(19) United States
(12) Patent Application Publication
(10) Pub. No.: US 2024/0100432 A1
(43) Pub. Date: Mar. 28, 2024

(54) SIMULATION SYSTEM, SIMULATION METHOD, AND SIMULATION PROGRAM

(71) Applicant: The Pokémon Company, Tokyo (JP)

(72) Inventor: Yosuke OSHINO, Tokyo (JP)

(73) Assignee: The Pokémon Company, Tokyo (JP)

(21) Appl. No.: 18/530,246

(22) Filed: Dec. 6, 2023

Related U.S. Application Data
(63) Continuation of application No. PCT/JP2022/009930, filed on Mar. 8, 2022.

(30) Foreign Application Priority Data
Jun. 7, 2021 (JP) 2021-095475

(51) Int. Cl. A63F 13/5378; A63F 13/822

(52) U.S. Cl. CPC A63F 13/5378; A63F 13/822

(57) ABSTRACT

A simulation system in which a user can assume and enjoy changes in an operation of a character in a case in which the character is operated inside a virtual space and that can be simultaneously played by a plurality of users is provided. For example, a simulation system includes processing circuitry configured to set commands in a plurality of characters and set an execution order of the commands in a case in which a plurality of commands are set operate the character inside a virtual space based on the commands and the execution order set in the character, set commands and an execution order based on an instruction from each user having each character, and operates one character and other characters inside the virtual space.

### CROSS-REFERENCE TO RELATED APPLICATIONS

This application is a continuation of International Application No. PCT/JP2022/009930, filed Mar. 8, 2022, which claims priority to JP 2021-095475, filed Jun. 7, 2021, the entire contents of each are incorporated herein by reference.

### BACKGROUND

### Technical Field

The present disclosure relates to a simulation system, a simulation method, and a simulation program. Particularly, the present disclosure relates to a simulation system, a simulation method, and a simulation program in which characters owned by a plurality of users operate in a virtual space.

### Description of Related Art

In the related art, there is a known game system that includes at least operation means, arithmetic means, and storage means and in which the arithmetic means proceeds with a game by performing arithmetic calculation based on information input by a team player from the operation means, and a game program and data which are stored in the storage means, the game system proceeding with a role playing game and a simulation game in parallel and associating the two games with each other, the role playing game being a game in which the arithmetic means completes a scenario by giving an instruction for an action of a character assigned to a game player, and the simulation game being a game in which the game player creates the game player's own world by editing it arbitrarily (see, for example, PTL 1). According to the game system disclosed in PTL 1, even a game player who has experienced a large number of role playing games can enjoy the game without getting bored because the game player's own world is provided as the world of the role playing game.

### CITATION LIST

### Patent Literature

[PTL 1] Japanese Patent Application Publication No. 2001-079269

### SUMMARY

### Technical Problems

However, in the game system disclosed in PTL 1, although a user can set an action of a character, the character acts faithfully according to the setting of the user and the range of action is not limited, and thus it is difficult to make the character's action unexpected. In the game system disclosed in PTL 1, a plurality of users setting behaviors of characters thereof and performing cooperation, battles, and the like among the users in a game are not considered at all.

Thus, an object of the present disclosure is to provide a simulation system, a simulation method, and a simulation program that allow a user to estimate and enjoy a change in a character's operation in a case in which the character is operated in a virtual space and can be simultaneously played by a plurality of users.

### Solutions to the Problems

In order to achieve the object described above, the present disclosure provides a simulation system including: a command setting unit configured to be able to set one or more commands for each of characters that can be disposed in a virtual space configured by a plurality of virtual unit spaces and are associated with a plurality of users and set an execution order of the commands in a case in which a plurality of commands are set; and an operation control unit configured to operate the character inside the virtual space on the basis of the commands and the execution order set for the character, in which the command setting unit is configured to be able to set the commands and the execution order based on an instruction of each user associated with each character in association with one or more characters, and the operation control unit causes a first character associated with a first user to operate inside the virtual space on the basis of the commands and the execution order set for the first character regardless of an instruction from a second user by receiving an instruction from the first user and causes a second character associated with a second user to operate inside the virtual space on the basis of the commands and the execution order set for the second character regardless of an instruction from the first user by receiving an instruction from the second user.

### Advantageous Effects

According to a simulation system, a simulation method, and a simulation program according to the present disclosure, the simulation system, the simulation method, and the simulation program that allow a user to be able to estimate and enjoy a change in a character's operation in a case in which the character is operated in a virtual space and can be simultaneously played by a plurality of users can be provided.

### BRIEF DESCRIPTION OF DRAWINGS

FIG. 1 is a schematic view of a simulation system according to an exemplary embodiment.

FIG. 2 is a schematic view of a simulation system according to an exemplary embodiment.

FIG. 3 is a schematic view of a simulation system according to an exemplary embodiment.

FIG. 4 is a schematic view of a simulation system according to an exemplary embodiment.

FIG. 5 is a functional configuration block diagram of the simulation system according to an exemplary embodiment.

FIG. 6 is a data configuration diagram of storage parts included in a storage unit according to an exemplary embodiment.

FIG. 7 is a diagram illustrating the flow of processing of a case in which processing in the simulation system according to an exemplary embodiment is a real-time system.

FIG. 8 is a diagram illustrating the flow of processing of a case in which processing in the simulation system according to an exemplary embodiment is a turn system.

FIG. 9 is a flowchart of processing in the simulation system according to an exemplary embodiment.

### DETAILED DESCRIPTION

### Embodiment

### <Outline of Simulation System 1>

A simulation system 1 according to an exemplary embodiment can be configured to include information terminals of a plurality of users and a server that performs a predetermined process of a simulation as an example. The information terminals and the server are connected through a communication network to be able to bidirectionally communicate with each other. In addition, the communication network is a communication network such as a mobile telephone network and/or the Internet. The communication network can also include a communication network such as a wired LAN or a wireless LAN. Furthermore, the simulation system 1 may be a simulation system of a server-client type. In the following description, an example in which the simulation system 1 includes information terminals of a plurality of users and a server that performs a predetermined process of a simulation will be described as an example.

The simulation system 1 disposes characters and/or objects owned by the plurality of users in a virtual space (field) and sets one or more requests that are desired to be executed for a character owned by each user in the virtual space by the user and an execution order of the requests. Then, by being triggered upon an instruction of execution of requests for a character owned by each user, the simulation system 1 causes the character to execute the requests according to the execution order in the virtual space. In other words, in the simulation system 1, in a case in which one user has one character, and another user has another character, the one user sets requests and an execution order for the one character, and the other user sets requests and an execution order for the other character. Then, in a case in which the one user instructs the one character to execute requests, the simulation system 1 causes the one character to execute the requests according to the execution order inside the virtual space regardless of (that is, independent from) the instruction of the other user. In addition, in a case in which the other user instructs the other character to execute requests, the simulation system 1 causes the other character to execute the requests according to the execution order inside the virtual space that is the same as the virtual space in which the one character is present regardless of (that is, independent from) the instruction of the one user.

In this case, in a case in which the one user instructs execution of requests simultaneously with outputting operations of a character and/or an object of the one user to a display unit or the like of an information terminal of the one user, after the other user instructs execution of requests, the simulation system 1 also outputs operations of the other character and/or an object to this display unit or the like. This similarly applies to the information terminal of the other user.

In addition, the simulation system 1 divides the virtual space into a plurality of areas and assigns each of the areas to (in other words, associates the areas with) one of a plurality of users. Each of the plurality of areas is an area (an operable area) in which an operation on a character and/or object owned by a user can be performed by the user associated with the area. For example, in a case in which one area is assigned to one user, this one area is prohibited from being assigned to other users. Then, in the simulation system 1, each user disposes one or more characters in the area assigned to the user and sets requests and an execution order thereof for each character. In an area, a predetermined object can be disposed as well.

Then, in the simulation system 1, one user can dispose a character and/or an object owned by him or her only inside one area (inside his or her own area), and disposition thereof inside another area is prohibited. In other words, in the simulation system 1, in a case in which a character is disposed in an area for the first time, in one area assigned to the one user, only one character owned by the one user can be disposed, and disposition of the one character in other areas allocated to other users is prohibited. In addition, the simulation system 1 enables an object owned by one user to be disposed in one area and prohibits the object from being disposed in other areas. Here, after one character disposed in one area moves from the one area to another area and enters the area on the basis of a command of one user, the simulation system 1 may permit addition or resetting of a command performed by the one user for this one character.

In addition, the simulation system 1 causes a first character and/or a second character to execute a predetermined operation together with or with preference over a set request on the basis of a combination of features of a first character and features of a second character or features of a predetermined object and/or requests executed by the first character and/or the second character before presence at this position, and the like in a case in which characters are operated in a virtual space, and one character (the first character) and the other character (the second character) different from this one character or a predetermined object, and the like are present at the same position. In addition, a user having the first character and a user having the second character may be either the same as or different from a user having the first character and a user having the object.

Further, the simulation system 1 constitutes a virtual space by a plurality of virtual unit spaces. In addition, unique feature can be associated with each virtual unit space. The simulation system 1 can also cause a character to execute a predetermined operation together with or with preference over a set request based on a combination of features of the character and features of a virtual unit space in which the character exists in a case in which the character is operated in a virtual space, and/or a request or the like executed by the character before the character exists at the position.

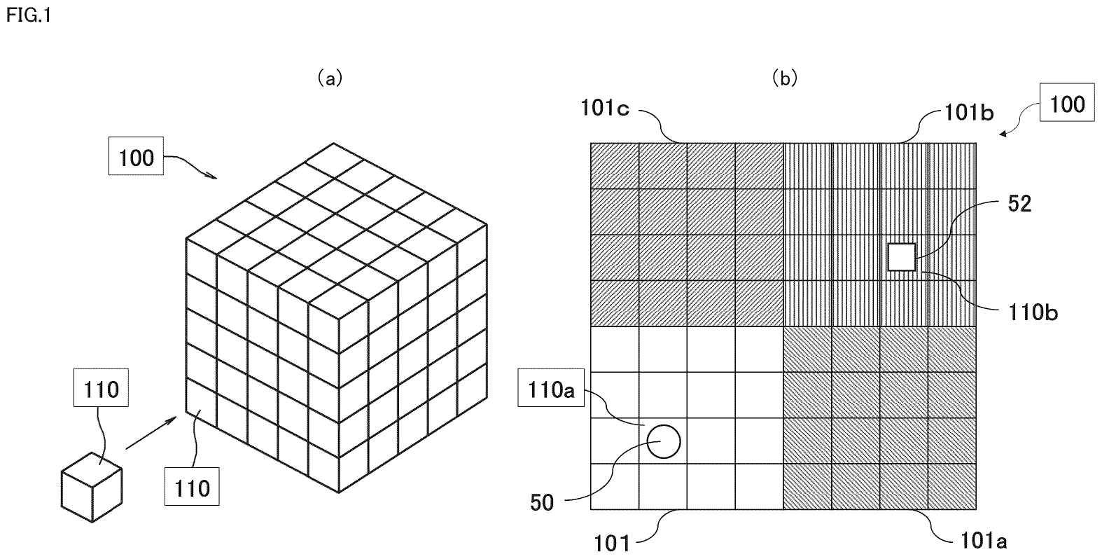

FIGS. 1 to 4 illustrate an example of outlines of the simulation system and operations according to an exemplary embodiment.

More specifically, the simulation system 1 is a system causing characters owned by a plurality of users inside the same virtual space to execute predetermined operations on the basis of requests (hereinafter referred to as “commands”) set by each of the plurality of users and an execution order of the commands. In other words, in the simulation system 1, each of a plurality of users has one or more characters. Then, the simulation system 1 accepts an instruction from one user and sets commands and an execution order of the commands for one character owned by this one user. In addition, the simulation system 1 accepts instructions from another user and sets the commands and an execution order of the commands for another character owned by this other user. The simulation system 1 causes one character to execute commands according to the execution order regardless of instructions of other users by being triggered upon reception of an instruction of command execution from one user and causes another character to execute commands according to the execution order regardless of the instructions of the one user by being triggered upon reception of an instruction of command execution from another user.

### (Regarding Virtual Space 100)

In this exemplary embodiment, a virtual space is configured by connecting a plurality of constituent units (hereinafter referred to as “virtual unit space”). As an example, as illustrated in FIG. 1(a), a virtual space 100 is configured using an aggregation of a plurality of virtual unit spaces 110. Although boundary lines of the virtual unit spaces 110 are illustrated in FIG. 1(a), in a case in which the virtual space 100 is displayed in a display unit of an information terminal or the like, the boundary lines may not be displayed. FIG. 1(a) illustrates an example in which the virtual space 100 of a cubic shape is configured by aggregating a plurality of virtual unit spaces 110 having cubic shapes (that is, a virtual stereoscopic square). (Although an example in which the virtual space 100 is configured using an aggregation of virtual unit spaces of 5×5×5 is illustrated as an example, the size of the aggregation is not limited thereto. For example, the virtual space may be an aggregation of virtual unit spaces of m×n×o. Here, m, n, and o are positive integers that are the same as or different from each other). In addition, the shape of the virtual space 100 is not limited to a stereoscopic shape and may be any shape as long as it is an aggregation of a plurality of virtual unit spaces 110. In this way, by configuring the virtual space 100 using the virtual unit spaces 110, movement designation of a character between virtual stereoscopic squares (in other words, movement designation in units of the virtual unit spaces 110) and designation of a predetermined operation of a character in a stereoscopic square can be performed, and thus the simulation system 1 that can be easily operated in spite of a high degree of freedom of movement and operations of a character can be provided.

In addition, the shape of the virtual unit space 110 is not particularly limited. However, in an exemplary embodiment, the virtual unit space 110 be configured to have, for example, a cube shape from the viewpoint of securing the ease of configuration of the virtual space 100, or the like. In addition, the plurality of virtual spaces 100 may be connected to each other. Note that the virtual unit space 110 may be configured to have any of other shapes such as a rectangular parallelopiped shape and a spherical shape. In addition, for the virtual unit space 110, a plurality of virtual unit spaces having the same or different shapes may be connected to each other, the connected portions (joint portions) may be treated as nonexistent, and the plurality of connected virtual unit spaces may be treated as one virtual unit space. In an exemplary embodiment, an example in which the virtual unit space 110 has a cube shape and the virtual space 100 also has a cube shape is described.

### (Regarding Area)

In the simulation system 1, the virtual space 100 is configured to include a plurality of areas. In addition, each area is configured to include a plurality of virtual unit spaces 110. For example, as illustrated in FIG. 1(b), the virtual space 100 is configured to include an area 101, an area 101a, an area 101b, and an area 101c. In addition, for simplification of description, FIG. 1(b) illustrates a plan view of the virtual space 100. In the example illustrated in FIG. 1(b), although the virtual space 100 is configured to include four areas, the number of areas is not limited to four as long as it is two or more. Furthermore, the shape and the size of the area can be freely set as well.

Here, in the simulation system 1, one area is associated with one user. For example, the area 101 is associated with a first user, the area 101a is associated with a second user, the area 101b is associated with a third user, and the area 101c is associated with a fourth user. In addition, the virtual space 100 may have an area (a neutral area) not associated with a user. In other words, while the area 101 may be associated with the first user, and the area 101b may be associated with the second user, the areas 101a and 101c may be associated with no user. In addition, a team formed from a plurality of users may be set, and the team may be associated with an area. In this case, one area is associated with a plurality of users of the same team.

(Disposition of Character and/or Object in Area)

The simulation system 1 disposes a predetermined character in a predetermined area of the virtual space 100 in accordance with instructions from a plurality of users or in advance. For example, the area 101 is associated with the first user, and the area 101b is associated with the second user. In this case, the simulation system 1 limits the disposition of a character 50, which is a character 50 owned by the first user and for which commands and an execution order of the commands have not been set yet, in the virtual space 100 to the inside of the area 101. As an example, as illustrated in FIG. 1(b), the simulation system 1 disposes a character 50 in the virtual unit space 110a of the inside of the area 101 on the basis of an instruction of the first user.

On the other hand, the simulation system 1 prohibits disposition of the character 50, which is performed by the first user, in a virtual unit space of areas other than the area 101. Similarly, the simulation system 1 limits disposition of a character 52, which is a character 52 owned by the second user and for which commands and an execution order of the commands have not been set yet, in a virtual space to the inside of the area 101b. Then, on the basis of an instruction of the second user, the simulation system 1 disposes the character 52 in the virtual unit space 110b of the inside of the area 101b and prohibits disposition of the character 52, which is performed by the second user, in a virtual unit space of an area other than the area 101b.

In other words, in the simulation system 1, in a case in which a character and/or an object is disposed in an area for the first time (hereinafter, a position at which a character and/or an object is disposed in an area for the first time, that is, a position at which a character and/or an object starts an operation inside the virtual space 100 for the first time, will be referred to as an “operation start position”), a user can dispose the character and/or the object owned by him or her inside his or her area and cannot dispose the character and/or the object inside an area of another person. In other words, the operation start positions of a character and an object are limited to the inside of an area associated with a user having this character and this object.

In addition, in a case in which a team formed from a plurality of users is set, each of the plurality of users belonging to this team can dispose a character and/or an object owned by him or her in an area associated with the team. However, even in the case of the same team, operations of other users of the same team for a character and/or an object owned by one user may be prohibited. Here, for example, in a case in which a plurality of teams having one or more users are set, the simulation system 1 can impose a predetermined limit on the disposition of a character and an object owned by each user. For example, when two teams including a team (a friend team) including user A and user B and a team (an enemy team) including other users are set, as below, conditions may be set on initial dispositions (that is, operation start positions) of a character and an object. In this case, an area includes an area for the user A (own area), an area for the user B (friend area), and an area of the enemy team (enemy area).
(i) The user A can set operation start positions of a character and an object associated with the user A to the inside of his or her own area.
(ii) The user A can set the operation start position of a character associated with the user A to the inside of a friend area and can set the operation start position of an object only to the inside of his or her own area. Alternatively, the user A can set the operation start position of an object associated with the user A to the inside of a friend area and can set the operation start position of a character only to the inside of his or her own area.
(iii) The user A cannot set the operation start positions of a character and an object associated with the user A to the inside of an enemy area.

The conditions (i) to (iii) described above similarly apply to the user B and other users.

In addition, some areas of a plurality of areas may be set as areas having the following features.
(a) An area in which any user can dispose his or her character and/or object for the first time.
(b) An area in which no user can dispose his or her character and/or object.
(c) An area that is associated with a user having a character that has arrived first among characters of a plurality of users. After the area is associated with the user having the character that has arrived first, only a character of this user can be disposed in this area.
(d) An area associated with a user that changes at a time interval set in advance. For example, a user with which the area is associated is switched from one user to another user every one minute.
(e) An area associated with a user satisfying a predetermined condition in a case in which this condition is satisfied. For example, the predetermined condition is use of a predetermined item or the like.
(f) An area associated with a user having a lowest achievement degree by referring to a target achievement degree of each user in a case in which a target to be achieved by each user is set.

### (Regarding Setting of Commands and Execution Order of Commands)

In a case in which a first user sets one or more commands and an execution order of the commands for a character 50, and an instruction of command execution is received from the first user, the simulation system 1 operates the character 50 inside the virtual space 100 on the basis of the commands and the execution order of the commands. Here, the operation of the character 50 of the first user is executed regardless of the commands and the execution order of the commands set by a second user and an instruction of command execution. Similarly, the simulation system 1 also operates a character 52 on the basis of commands and an execution order of the commands set by the second user on the basis of an instruction from the second user. Similar to the character 50, the operation of the character 52 of the second user is executed regardless of commands and an execution order of the commands set by the first user and an instruction of command execution.

Here, in a case in which a character moves from an area associated with a user having this character to an area not associated with this user in accordance with execution of a command, the simulation system 1 can enable addition and/or change of commands and an execution order of the commands for this character. For example, in a case in which the character 50 of the first user moves from an area 101 to an area 101a in accordance with execution of a command, the area 101a is not an area associated with the first user. However, the simulation system 1 can enable settings of a command (for example, change or stop of a command that has been set and/or addition of a new command) for the character 50 of the inside of the area 101a on the basis of an instruction from the first user. More specifically, the simulation system 1 limits operation start positions of a character and an object to the inside of an area associated with a user having this character and this object and does not limit the settings of commands for the character and/or the object to the inside of this area. In other words, in the case of a character and an object associated with this user, the simulation system 1, also in a case in which this character and this object are present at certain positions of the inside of the virtual space 100, can enable settings of commands and an execution order of the commands for the character and the object.

In addition, in a case in which a positional relation between the character 50 and the character 52 inside the virtual space 100 satisfies a predetermined relation (for example, in a case in which they are positioned in the same virtual unit space), the simulation system 1 causes at least one of the character 50 and the character 52 to execute a predetermined operation with preference over commands set for the character 50 and the character 52. In accordance with this, at least one of the character 50 and the character 52 performs an operation other than assumed operations (that is, operations that are not present in set commands), and thus the amusement of a simulation according to unexpectedness of the operation can be raised.

### (Regarding Target Set by User)

The simulation system 1 may set a target to be achieved for each user. By disposing a character and/or an object owned by each user inside his or her area and causing the character to execute a command with commands and an execution order of the commands being set for the character, the user can enjoy achievement of the set target. For example, in a case in which arrival at a predetermined place (goal place) of another area of another user is set for one character of one user as a target, the one user disposes the one character in his or her own area, one or more commands and an execution order of the commands are set for the one character, and arrival of the one character at the goal place is set as the target. On the other hand, another user can disturb target achievement of one user by predicting a path of one character to a goal place and installing an object disturbing movement of the one character to the inside of another area or installing another character for which commands for disturbing movement of the one character to the goal place and an execution order of the commands are set inside another area.

### (Example of Disposition, Commands, and Execution Order of Commands)

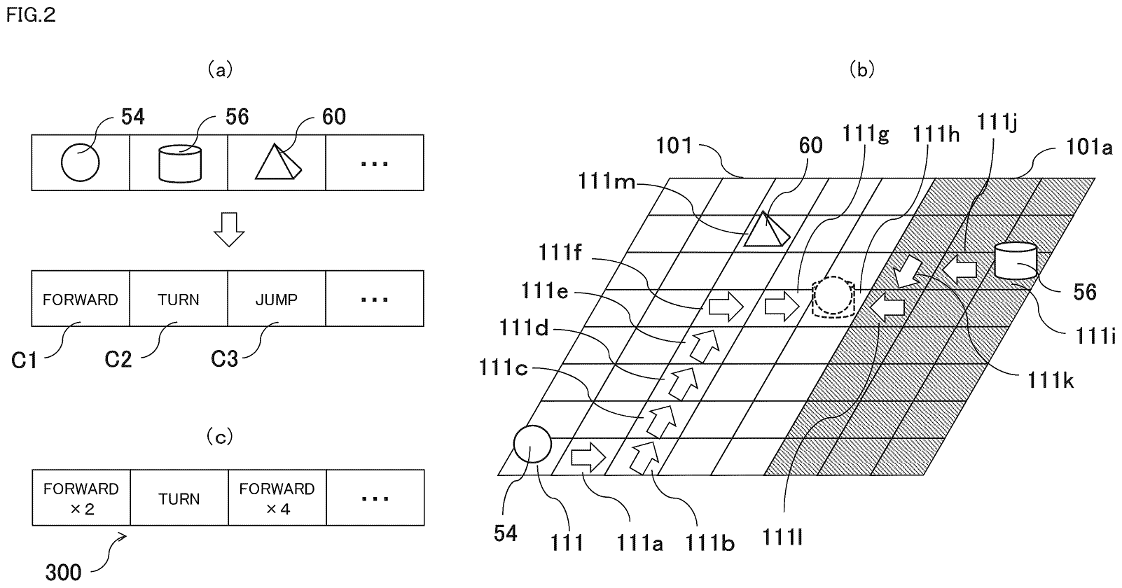

An example of disposition of a character and an object and settings of commands and an execution order of the commands for the character will be described with reference to FIGS. 2 to 4. In FIGS. 2 to 4, an example in which a first user and a second user use the simulation system 1, the first user is associated with an area 101, and the second user is associated with an area 101a is illustrated. In addition, in FIG. 2, a virtual space 100 is configured to include the area 101 and the area 101a adjacent to the area 101, the area 101 is an unshaded area, and the area 101a is a shaded area. Furthermore, in FIG. 2, although an example in which a plurality of characters and objects are disposed in the virtual space 100 is illustrated, the number of characters and/or objects disposed in the virtual space 100 may be one or more.

In addition, in FIG. 2(b), for simplification of description, only a lower surface of each virtual unit space is illustrated (thus, in FIG. 2(b), only a lower surface of the virtual space 100 is illustrated). Thus, the simulation system 1 can dispose a character and an object not only on the lower surface of the virtual space 100 but also in a virtual unit space above the lower surface.

First, a first user selects a character to be disposed in the area 101 among characters and/or objects owned by him or her. For example, the simulation system 1 displays characters and objects owned by the first user in an information terminal of the first user (see the upper diagram in FIG. 2(a)) and selects a character on the basis of selection of the first user. In the information terminal of the first user, as one example, a character 54, a character 56, an object 60, and the like owned by the first user are displayed. In the example illustrated in FIG. 2, it is assumed that the first user has selected the character 54.

Then, the simulation system 1 disposes the character 54 in the virtual unit space 111 of the area 101 instructed by the first user. Subsequently, the simulation system 1 causes the information terminal of the first user to display various commands set for the character (see a lower diagram in FIG. 2(a)). In the information terminal of the first user, as one example, a command C1 designating “forward”, a command C2 designating “turn”, a command C3 designating “jump”, and the like are displayed. The simulation system 1 sets one or more commands and an execution order of the commands in the character 54 on the basis of an instruction from the first user. On the other hand, similarly, for the second user, the simulation system 1, on the basis of an instruction from the second user, disposes the character 56 owned by the second user in a virtual unit space 111i and sets commands and an execution order of the commands for the character 56.

Here, the character is a character that can appear in the simulation system 1, and is a character that can be disposed in the virtual space 100 and for which a user can set a command for an operation in the virtual space 100. In addition, the object is an object that can be installed in a predetermined virtual unit space 110 constituting the virtual space 100 in response to a user's instruction, and is an object representing an arrangement or the like that can or cannot be interfered with by a character. In addition, features such as the terrain or weather of the virtual unit space may be set in the virtual unit space 110. Note that the object also includes a character that does not substantially operate in the virtual space 100 or a derived object which is an object associated with the operation of the character, and an environment-specific object (environment object) associated with the terrain, weather, or the like of the virtual unit space 110.

Further, the interference means that one character has a predetermined influence on a character other than the one character and/or an object, and/or one character has a predetermined influence on a predetermined virtual unit space in a case in which the one character is present in the same or a nearby virtual unit space as the other character and/or an object and/or in a case in which the one character is present in a predetermined virtual unit space or a virtual unit space in the vicinity of the predetermined virtual unit space.

Examples of the predetermined influence include various influences. For example, it is possible to set various influences such as an influence of pushing one character to another virtual unit space, an influence of destroying an object in the same virtual unit space, and an influence of changing the state of the virtual unit space.

For example, in FIG. 2(b), the first user sets commands for the character 54, and the second user sets commands for the character 56. As one example, the simulation system 1, on the basis of an instruction from the first user, designates commands acquired by appropriately combining various commands such as the command C1 (“forward” command), the command C2 (“turn” command), and/or the command C3 (“jump” command), and the like and sets an execution order of the commands for the character 54 such that the character 54 arrives at a virtual unit space 111b from a virtual unit space 111 through a virtual unit space 11a, changes the direction in the virtual unit space 1l1b, advances to a virtual unit space 1l1c, a virtual unit space 111d, a virtual unit space 111e, and a virtual unit space 1l1f, and changes the direction again in the virtual unit space 1l1f and arrives at a virtual unit space 111h through a virtual unit space 111g. In FIG. 2(b), when a direction from the virtual unit space 111 to the virtual unit space 111a is represented as “forward”, the character 54 advances forward by two squares, turns to the left side from the advancement direction in the virtual unit space 111b and advances by 4 squares, and turns to the right side from the advancement direction in the virtual unit space 1l1f and advances by 2 squares.

Similarly, the simulation system 1 sets commands and an execution order of the commands also for the character 56 on the basis of an instruction from the second user. In the case of the character 56, commands and an execution order of the commands are set such that the character 56 advances from the virtual unit space 111i to the virtual unit space 111k through the virtual unit space 111j, turns left from the advancement direction in the virtual unit space 111k and moves to the virtual unit space 111l, further turns right from the advancement direction and advances in the virtual unit space 111l, and arrives at the virtual unit space 111h. On the other hand, the simulation system 1 disposes the object 60 in the virtual unit space 111m on the basis of an instruction from the first user. Then, the simulation system receives an instruction of command execution from the first user, causes the character 54 to execute a command, receives an instruction of command execution from the second user, and causes the character 56 to execute a command.

Here, the simulation system 1 can output the commands and the execution order of the commands that are set by the user such that the user can perceive them. For example, the simulation system 1 can be executed in an information terminal, and can display the commands and the execution order that are set by the user on a display unit of the information terminal, together with or separately from the virtual space 100. For example, details of the commands and the execution order are displayed as a command 300 by using text and the like as illustrated in FIG. 2(c). In the example illustrated in FIG. 2(c), some of the command details set for the character 54 of the first user are displayed. For example, the simulation system 1 causes the information terminal of the first user to perform display indicating that commands 300 including details in which, after the “forward” command is repeated twice, the “turn” command for a predetermined direction is executed, and subsequently, the “forward” command is repeated four times are set for the character 54. Similarly, the simulation system 1 causes the information terminal of the second user to display commands and an execution order of the commands set for the character 56 by the second user. Then, by executing commands set by each user in the execution order set by each user, the simulation system 1 operates each character inside the virtual space 100.

In addition, in the simulation system 1, an operation (for example, an operation such as putting a technique into operation or jumping in place) executed inside a virtual unit space in which a character is present may be configured to be able to be operated in accordance with a user's instruction even when the simulation system 1 is in the middle of execution of an operation of the character.

### (Example of Interference Between Character 54 and Character 54a)

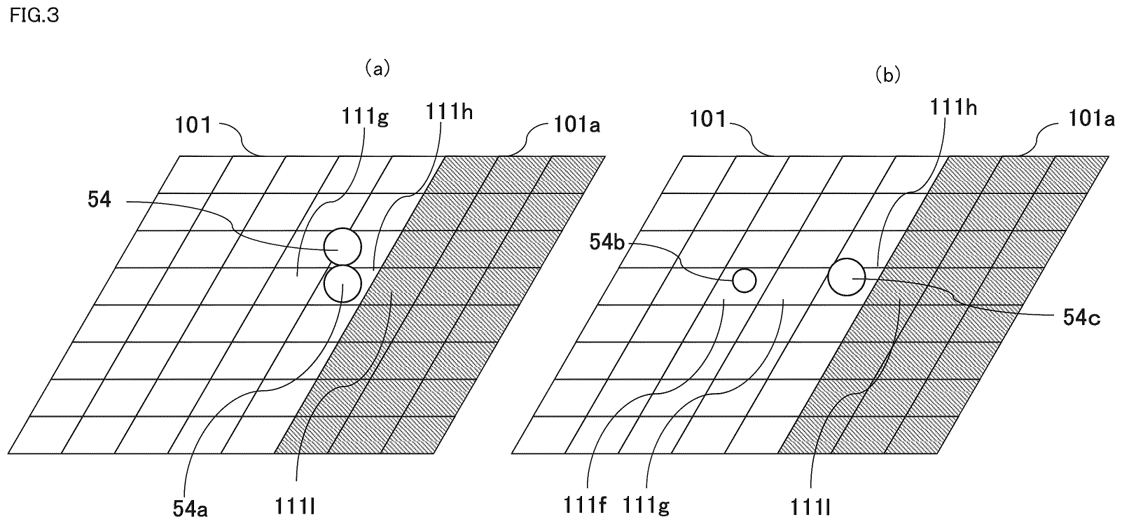

For example, as illustrated in FIG. 3(a), it is assumed that a command (a first command) to “jump” from a virtual unit space 111g to a virtual unit space 111h is set for the character 54 of the first user, and a “forward” command (a second command) from a virtual unit space 111l to the virtual unit space 111h is set for the character 54a of the second user. When the first command is executed in accordance with an instruction from the first user, the character 54 jumps from a virtual unit space 11g and arrives at the virtual unit space 111h, and when the second command is executed in accordance with an instruction from the second user, the character 54a advances from the virtual unit space 111l and arrives at the virtual unit space 111h. Then, the character 54 and the character 54a are present in the same virtual unit space 111h. In this case, the simulation system 1 controls the operation of the character 54 in the virtual unit space lllh on the basis of a combination of features of the character 54 and features of the character 54a and a command immediately before the arrival of the character 54 at the virtual unit space 111h. In other words, the simulation system 1 controls the operation of the character 54 on the basis of a condition set in advance without depending on (or with preference over) a user's settings.

For example, the simulation system 1 performs setting in advance such that an operation of loading one character on another character present in a virtual unit space is executed in a case in which a plurality of characters present in the same virtual unit space are characters of the same type, and one character arrives at this virtual unit space from a virtual unit space adjacent to this virtual unit space through “jump”. Since the character 54 and the character 54a are characters of the same type, and the character 54 has executed the command to jump immediately before arrival at the virtual unit space 111h, the simulation system 1, as illustrated in FIG. 3(a), operates the character 54 such that the character 54 gets on top of the character 54a. In addition, the simulation system 1 may perform setting in advance such that an operation of one character colliding with another character present in a virtual unit space and staying at that place (a virtual unit space adjacent to a virtual unit space in which the other character is present) or an operation of both one character and another character jumping in opposite directions, and the like are executed in a case in which a plurality of characters present in the same virtual unit space are characters of the same type, and one character has arrived at a virtual unit space from a virtual unit space adjacent to this virtual unit space through “forward”.

### (Example of Interference Between Character 54b and Character 54c)

In addition, for example, as illustrated in FIG. 3(b), it is assumed that a “forward” command (a first command) from a virtual unit space 111g to a virtual unit space 111h is set in a character 54b of a first user, and a “forward” command (a second command) from a virtual unit space 111l to the virtual unit space 111h is set in a character 54c of a second user.

When the first command is executed in accordance with an instruction from the first user, the character 54b advances from the virtual unit space 111g and arrives at the virtual unit space 111h, and when the second command is executed in accordance with an instruction from the second user, the character 54c advances from the virtual unit space 111l and arrives at the virtual unit space 111h. Then, the character 54b and the character 54c are present in the same virtual unit space 111h. In this case, the simulation system 1 controls the operation of the character 54b in the virtual unit space lllh on the basis of a combination of features of the character 54b and features of the character 54c and a command immediately before arrival of the character 54b at the virtual unit space 111h. Here, it is assumed that the type of the character 54b and the type of the character 54c are the same, and the size of the character 54b is smaller than the size of the character 54c.

For example, in a case in which, for a plurality of characters present in the same virtual unit space, the types of the characters are the same, and the size of one character that arrives at this virtual unit space is smaller than the size of another character presented in this virtual unit space, the simulation system 1 sets in advance to cause one character to execute an operation of colliding with another character present in the virtual unit space and going back to a virtual unit space on a further rear side of the original virtual unit space to which the one character has moved. In addition, in this case, a character having a larger size (in this case, another character) is set in advance to execute an operation with being present in this virtual unit space.

Here, in the example illustrated in FIG. 3(b), the size of the character 54c is larger than the size of the character 54b. Then, in a case in which the character 54c is present in the virtual unit space 111h, as illustrated in FIG. 3(b), the simulation system 1 operates the character 54b to be flipped by the character 54c and return to the virtual unit space 111f by going back through the original path through which it has moved.

### (Example of Interference Between Character 56 and Object 60)

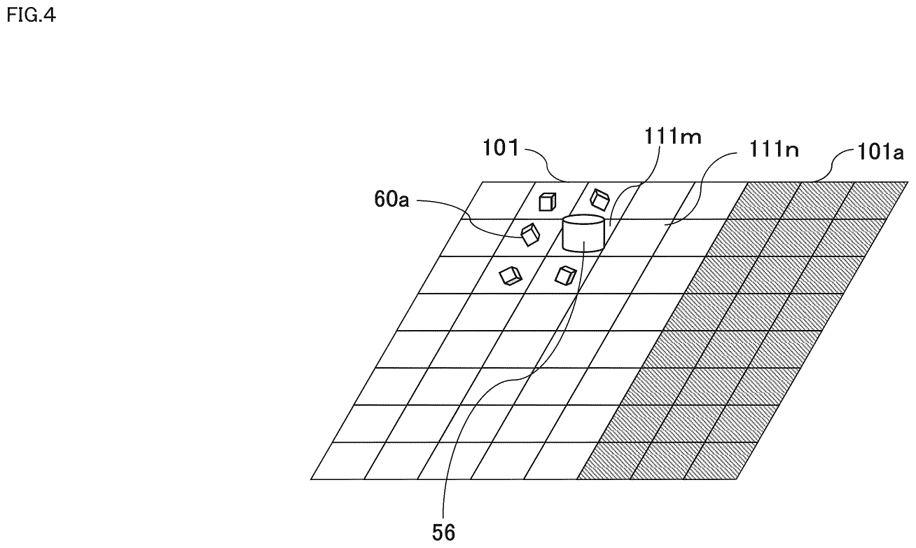

In addition, as illustrated in FIG. 4, it is assumed that the character 56 owned by the second user has moved from the area 101a associated with the second user toward a virtual unit space 111m of the area 101 associated with the first user and further moves to the virtual unit space 111m on the basis of a command for movement from the virtual unit space 111n to the virtual unit space 111m through jumping. Furthermore, it is assumed that an object 60 is installed in the virtual unit space 111m by the first user.

In this case, the character 56 jumps from the virtual unit space 111n and arrives at the virtual unit space 111m. Then, the character 56 and the object 60 are present in the same virtual unit space 111m. In this case, the simulation system 1 controls an operation in the virtual unit space 111m of the character 56 based on a combination of features of the character 56 and features of the object 60 and a command immediately before the character 56 reaches the virtual unit space 111m.

For example, in a case in which one character and a predetermined object are present in the same virtual unit space, the simulation system 1 sets in advance that the predetermined object can receive a predetermined interference from the character. Here, as one example, the interference represents that the predetermined object can be destroyed by the character. Then, in a case in which one character arrives from a virtual unit space from a virtual unit space adjacent to this virtual unit space through “jump”, the simulation system 1 sets execution of an operation of destroying an object present in this virtual unit space in advance. Then, since the character 56 has executed the command for jumping immediately before arrival at the virtual unit space 111m, the simulation system 1, as illustrated in FIG. 4, operates the character 56 and the object 60 such that the object 60 is destroyed by the character 56, and a plurality of objects 60a that are broken parts of the object 60 are scattered in the vicinity of the virtual unit space 111m.

Note that, in a case in which one character and a predetermined object are present in the same virtual unit space, it is also possible to set, in advance, the execution of an operation in which the one character is flipped by the object and returns to the original virtual unit space without destroying the object present in the virtual unit space in a case in which a predetermined interference from the character is set to be unable to be applied to the predetermined object in advance and in a case in which the one character has arrived at this virtual unit space from a virtual unit space adjacent to this virtual unit space through “jump” or “forward”. In addition, in a case in which one character advances to a virtual unit space in which a predetermined object is present, a predetermined interference from a predetermined character is set in advance to be unable to be applied to the predetermined object, and the one character is assumed to have an attribute of “passing through an object” as the attribute of this character. In this case, in a case in which the one character has arrived at a virtual unit space in which an object is present through “forward” from a virtual unit space adjacent to the virtual unit space in which the object is present, execution of an operation of the one character passing through the object and advancing to the virtual unit space adjacent to the object also may be set in advance without destroying the object present in the virtual unit space.

### (Size of Character and Object)

Note that the character and the object may have such a size to occupy the plurality of virtual unit spaces 110. For example, it is possible to use characters and/or objects having various sizes that occupy the plurality of virtual unit spaces 110 such as a character and/or an object having such a size to occupy eight virtual unit spaces 110 of 2×2×2 and a character and/or an object having such a size to occupy four virtual unit spaces 110 of 2×2×1. Further, in this case, the “interference” indicates that one character can have a predetermined influence on another character and/or object, and/or one character can have a predetermined influence on a predetermined virtual unit space not only in a case in which one or more virtual unit spaces 110 occupied by one character and/or object and one or more virtual unit spaces 110 occupied by another character and/or object are consistent with each other but also in a case in which at least parts thereof are common. For example, in a case in which one character occupies the plurality of virtual unit spaces 110, and another character overlaps all or a portion of the plurality of virtual unit spaces 110 (that is, in a case in which at least parts of the existence position of one character and the existence position of another character are common), “interference” may occur. Further, in a case in which one or more virtual unit spaces 110 occupied by one character and/or object and one or more virtual unit spaces 110 occupied by another character and/or object are consistent with each other, it may be recognized as a special interference, and predetermined interference processing may be executed, unlike a case in which parts thereof are common.

In this way, in the simulation system 1, first, each of a plurality of users can freely perform setting of commands for a character and setting of an execution order of the commands for a character and/or an object owned by him or her. Then, in the simulation system 1, the execution of an operation of each character of each user starts in accordance with commands set by each user and an execution order of the commands, and an interference occurs between one character and another character or the like in a predetermined case. In a case in which an interference has occurred, the simulation system 1 can control an operation executed by one character on the basis of a relation between the one character and another character or the like, a previous operation of the one character, or the like. In addition, the interference can be caused to occur between a plurality of characters owned by one user or between a character and an object owned by one user or occur between a character and/or an object owned by one user and a character and/or an object owned by another user.

Note that the virtual space 100 is constituted by the plurality of virtual unit spaces 110, and a character for which a command is set can move from one virtual unit space 110 to another virtual unit space 110 for each virtual unit space. Thus, the occurrence of interference between characters and/or between a character and an object or the like can be controlled for each virtual unit space, and thus the user can easily estimate the occurrence itself of interference (here, the user is not notified of the content of the interference such as what kind of interference occurs, and thus the user cannot easily estimate the occurrence of interference until the interference occurs actually) without strictly controlling a movement command for a character (that is, without strictly setting the determination of a contact between characters or between a character and an object).

In other words, in the simulation system 1, commands and/or an order of the commands set by each of a plurality of users are not limited to be executed as those in the settings of each user, and various changes occur in the operation of a character in accordance with a combination of features of the character and features of an object disposed in the virtual space 100 and/or features of the virtual unit space 110. Thus, according to the simulation system 1, in a case in which a plurality of characters are used, each user can execute a simulation while reviewing, assuming, or imaging various operations and changes in the operations such as whether an interesting behavior can be observed by using a specific character as a certain character, changes in the operation of the character in accordance with the object disposed in the virtual space 100, or each character performing a certain unexpected behavior by using a character owned by him or her in a character used by another user and the like. In accordance with this, in the simulation system 1, by performing various combinations of characters, objects, and/or virtual unit spaces, each of a plurality of users can observe and enjoy behaviors between characters (behaviors between characters owned by one user and/or between a character owned by one user and a character owned by another user) and behaviors of characters inside the virtual space 100.

In addition, the simulation system 1 can be realized using an information terminal or the like. The information terminal is a device that can be operated by a user. For example, the information terminal may be a mobile terminal such as a mobile phone, a smartphone, a tablet, or the like corresponding to a mobile communication system. Other than those, the information terminal, for example, may be a personal computer (PC) of a stationary type, a laptop PC, a notebook PC, a mobile game console, and/or a home game console, a game-dedicated device, or the like. In addition, details of the simulation system 1 according to an exemplary embodiment will be described below. However, names and numerical values in the above description and the following description are merely examples, and it is added that the present disclosure is not limited to these proper names and numerical values, and that these proper names and numerical values are not necessarily related to actual proper names and numerical values.

### <Details of Simulation System 1>

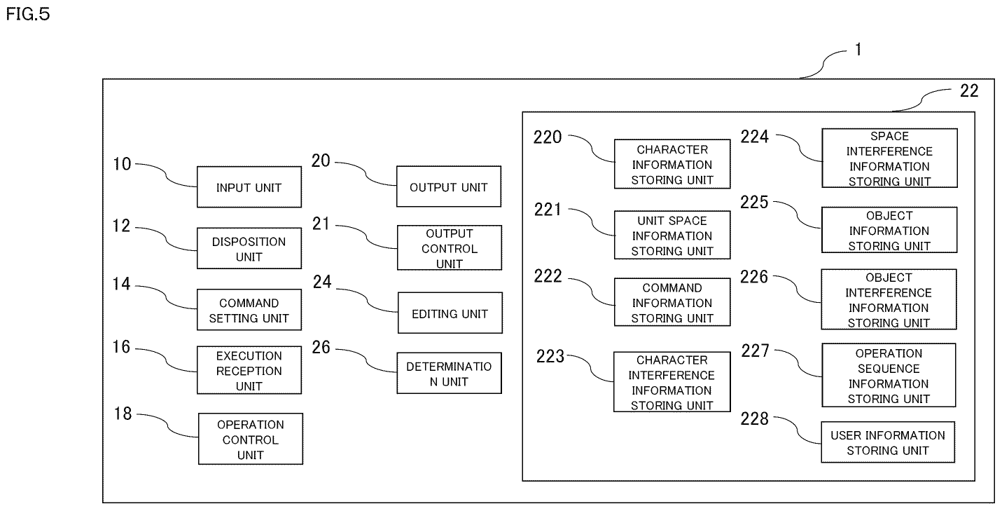

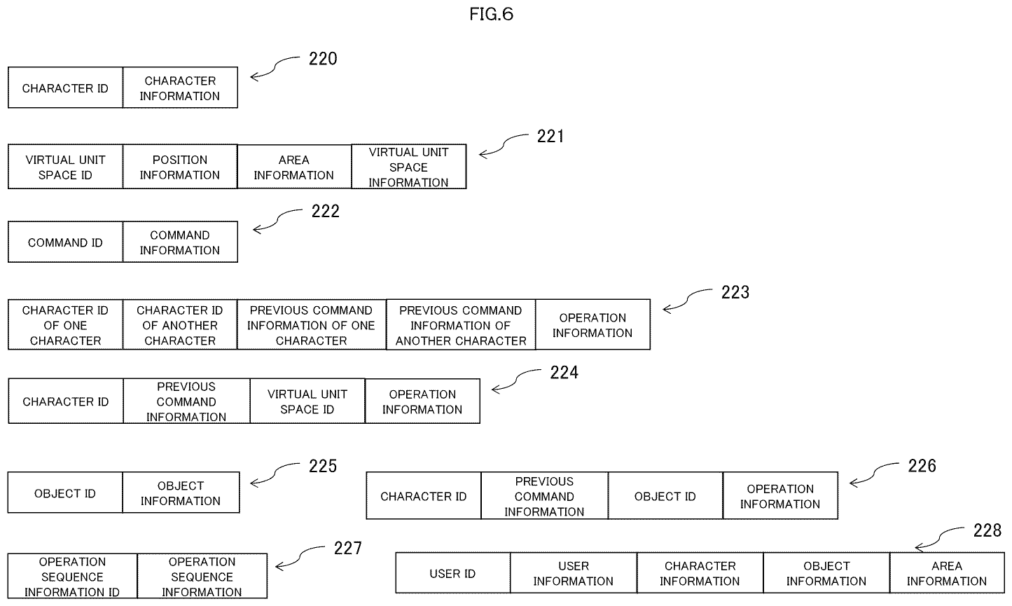

FIG. 5 illustrates an example of a functional configuration of the simulation system according to an exemplary embodiment. In addition, FIG. 6 illustrates an example of data configurations of storage parts included in the storage unit according to an exemplary embodiment.

### [Outline of Configuration of Simulation System 1]

The simulation system 1 according to an exemplary embodiment includes an input unit 10 that accepts inputs of a predetermined instruction and information of each of a plurality of users, a disposition unit 12 that disposes characters and the like of a plurality of users in the same virtual space 100, a command setting unit 14 that sets commands to be executed by a character of each of a plurality of users, an execution reception unit 16 that accepts execution of a command from each of a plurality of users, an operation control unit 18 that controls an operation of each character, an output unit 20 that outputs an operation and the like of each character, an output control unit 21 that controls an output of the output unit 20, a storage unit 22 that stores various kinds of information, an editing unit 24 that applies transformation and the like on a virtual unit space, an object, and the like, and a determination unit 26 that determines whether or not a predetermined condition set in each user has been satisfied in accordance with an operation of each character.

The storage unit 22 includes a character information storing unit 220 that stores information relating to characters, a unit space information storing unit 221 that stores information relating to virtual unit spaces, a command information storing unit 222 that stores information relating to commands, a character interference information storing unit 223 that stores information relating to interferences for characters, a space interference information storing unit 224 that stores information relating to an interference on the virtual space, an object information storing unit 225 that stores information relating to objects, an object interference information storing unit 226 that stores information relating to interferences on objects, an operation sequence information storing unit 227 that stores information relating to a series of operations of characters, and a user information storing unit 228 that stores information relating to users.

The simulation system 1 may not only include the plurality of components in physically the same device or location, but may also install some of the plurality of components at physically separated positions. For example, the simulation system 1 may cause an external server to play a role in performing some of the functions of the components. In addition, the simulation system 1 may be configured as one or more servers. In this case, the simulation system 1 is configured by combining a plurality of information terminals, components of one server, and components of another server. Further, in an exemplary embodiment, an aggregate of predetermined components can be perceived as one “information processing device”, and the simulation system 1 may be formed as an aggregate of a plurality of information processing devices. A method of distributing a plurality of functions required for realizing the simulation system 1 according to an exemplary embodiment to one or a plurality of pieces of hardware can be appropriately determined in consideration of the processing capability of each piece of hardware and/or specifications required for the simulation system 1, and the like. Further, various kinds of information stored in the storage unit 22 may be updated in accordance with a user's instruction or information received through the input unit 10, or predetermined information may be acquired from a predetermined server existing outside the simulation system 1 and updated at any time.

### [Details of Configuration of Simulation System 1]

In the following description, a case in which each of a plurality of users executes a simulation provided by the simulation system 1 mainly using an information terminal through a server will be described as an example. More specifically, for example, the simulation system 1 includes information terminals of the plurality of users and a server. In this case, each of the plurality of information terminals is configured to include at least an input unit 10 and an output unit 20. Then, the server is configured to include other components other than the input unit 10 and the output unit 20 and is connected to the plurality of information terminals to be able to communicate with each other through a communication network.

In addition, in the following description, although description will be presented using “one character” and “another character”, a user having one character and a user having another character may be the same or may be different from each other. In other words, a character different from the “one character” is used as “another character” regardless of a user having the character. Furthermore, in a case in which description is presented by employing “user” or “one user”, unless otherwise mentioned, each component similarly operates for “another user” that is different from “one user”.

### (Input Unit 10, Output Unit 20, and Output Control Unit 21)

The input unit 10 receives an input such as a predetermined instruction from a user. The input unit 10 is, for example, a touch panel, a keyboard, a mouse, a microphone, a motion sensor, or the like of the information terminal. The input unit 10 supplies the instruction to a predetermined component of the simulation system 1. Components having received the instruction exhibit predetermined functions.

The output unit 20 outputs various processing results of operations using characters before execution, during execution, and/or after execution in the simulation system 1 and an appearance of the virtual space 100 under the control of the output control unit 21. In other words, the output control unit 21 controls output details to be output to the output unit 20 on the basis of an instruction from a predetermined component of the simulation system 1 and/or information received from a predetermined component. Then, the output unit 20 outputs various kinds of processing results, information stored by the storage unit 22, the appearance of the virtual space 100, and the like such that they can be perceived by a user under the control of the output control unit 21. In addition, in the following description, unless otherwise mentioned, the output unit 20 outputs various kinds of information under the control of the output control unit 21.

More specifically, the output unit 20 outputs various processing results and stored information and the like as data of a predetermined format, a still image, a moving image, an audio, a text, and/or a physical phenomenon such as a vibration or the like. For example, the output unit 20 is a display unit, a speaker, a vibration unit (a device that is disposed inside the information terminal and generates a vibration using a predetermined electric signal), a light emitting unit, a data output unit, or the like of the information terminal. In addition, the output unit 20 can also output information regarding the disposition of a character, an object, or the like in the virtual space 100 which is set by a user, information indicating a command and the order of the command which are set for a character or an object, and/or information regarding a predetermined operation of a character having executed the operation due to interference to the outside in a predetermined data format in response to the user's instruction. In addition, the output unit 20 can also output information received from an external server.

In addition, the output unit 20 may output one area associated with one user and another area associated with another user among a plurality of areas configuring the virtual space 100 with output forms thereof being changed. For example, the output unit 20 of the information terminal of one user can output in a form in which it is more difficult to view areas other than one area. In other words, the output unit 20 of the information terminal of one user may output other areas of other users in a form different from that of the one area when seen from one user. In addition, the output unit 20 may or may not change output forms of one character owned by one user and another character owned by another user. For example, the output unit 20 of the information terminal of one user, also in a case in which one character is present in a certain area of a plurality of areas, can output the one character in an easily viewable form (a clear form) and can output another character of another user in a form that is more difficult to be viewed than that of the one character (for example, a form in which a position at which a character is present can be perceived, and a type of the character is unknown).

### (Storage Unit 22)

The storage unit 22 stores various information related to the simulation system 1. The storage units included in the storage unit 22 supply predetermined information to a predetermined component in response to a request received from another component of the simulation system 1.

### (Storage Unit 22: Character Information Storing Unit 220)

The character information storing unit 220 stores information relating to characters used in a simulation. More specifically, the character information storing unit 220 stores character information and the like in association with a character ID used for identifying a character. The character information represents features of a character and, for example, is information representing attributes of the character, a type of the character, a name of the character, a hit point (HP), a gender of the character, capabilities of the character, a technique of the character, an HP quantity of another character that can be reduced using the technique of the character, a size of the character, a weight (body weight) of the character, a maximum number of commands that can be received by the character in one instruction, a type of command that can be received by the character, presence/absence of a tool that is held, an experience value, a level, and the like.

Note that the attribute is information which is set for each character, and is the features of the character which are set in accordance with, for example, the type, state, properties, ability, or the like of the character. The attribute is not particularly limited, and examples thereof include attributes of names such as normal, flame, water, grass, ice, electricity, and ghost. Note that a plurality of attributes may be set for one character. In addition, the attributes may be attributes such as “techniques” remembered by the character or “skills” that are set for items that the character has. In this case, for example, the character may have both the attribute of the character itself and the attribute of a “technique” remembered by the character (may be the same as or different from the attributes of the character itself).

### (Storage Unit 22: Unit Space Information Storing Unit 221)

The unit space information storing unit 221 stores position information representing a position of a virtual unit space inside a virtual space, area information representing an area to which this virtual unit space belongs, and virtual unit space information that is information relating to topography, a weather, and the like associated with the virtual unit space and is information representing features of a virtual unit space in association with a virtual unit space ID for identifying the virtual unit space. Examples of the area information include area IDs used for identifying a plurality of areas configuring the virtual space 100 and the like. Examples of the virtual unit space information include topographical information, weather information, interference possibility information, and the like.

Specific examples of the topographical information include information indicating meadows, coasts, waterfront, mountains, rocky areas, towns, graveyards, or the like, and the virtual unit space is output from the output unit 20 as a virtual unit space indicating the terrain corresponding to the topographical information based on the associated topographical information. For example, as the virtual unit space, a virtual unit space including a characteristic object (this object may be an object that can be disposed by a user or disposed in advance by the simulation system 1) or the like in the terrain of each of a plurality of types such as meadows, coasts, and waterfront may be prepared in advance. In addition, the weather information, which is information regarding the weather that can be set for each virtual unit space, is information indicating, for example, fine weather, cloudy weather, rainy weather, thunderstorm, snow, or the like. The virtual unit space associated with the weather information is output from the output unit 20 as a virtual unit space indicating the weather corresponding to the weather information, based on the associated weather information.

In addition, the interference possibility information is information indicating whether a user and/or a character can interfere with a virtual unit space. For example, in a case in which the interference possibility information is information indicating that interference is possible, the editing unit 24 can receive a user's predetermined instruction through the input unit 10 for a virtual unit space in which interference is possible, and reflect the instruction in the virtual unit space. For example, in a case in which interference for deforming the terrain of a virtual unit space is possible, the editing unit 24 can deform the terrain of the virtual unit space in response to the user's instruction (as an example, deformation that destroys mountainous terrain, deformation that raises flat ground with soil, deformation that fills swamps, and the like). Further, in a case in which the interference possibility information is information indicating that interference is possible, interference such as destruction by a character may be enabled for a virtual unit space in which interference is possible. On the other hand, in a case in which the interference possibility information is information indicating that interference is not possible, interference by a user and a character is prohibited for a virtual unit space in which interference is not possible.

### (Storage Unit 22: Command Information Storing Unit 222)

The command information storing unit 222 stores command information indicating the content of a command to be executed by a character, in association with a command ID for identifying the command. The command information storing unit 222 stores a plurality of pieces of command information.

Here, the command includes at least one of a command for moving a character inside a virtual space without designating an arrival position inside the virtual space (in other words, an operation command for changing the virtual unit space in which the character is positioned without designating a virtual unit space of a movement destination to be a specific virtual unit space of the inside of the virtual space; hereinafter, referred to as a “first operation command”) and a command for executing a predetermined operation in any one of virtual unit spaces (in other words, an operation command for causing a character, which is positioned in a predetermined virtual unit space, to execute a predetermined operation in this predetermined virtual unit space; hereinafter, referred to as a “second operation command”). In addition, the command can also include an operation command for repeating the first operation command and/or the second operation command a predetermined number of times.

The first operation command includes commands regarding a direction of movement (that is, an operation of changing the position of a character to a virtual unit space adjacent to a predetermined virtual unit space) from the predetermined virtual unit space, the amount of movement, and a movement method, and examples thereof include commands such as moving forward, returning backward, moving right or left, jumping forward, jumping backward, jumping right or left, flying, rolling, crawling, and the like. In addition, the second operation command includes a command for executing a predetermined operation without moving from a predetermined virtual unit space, and examples thereof include commands such as changing the direction of a character in a predetermined direction, jumping on the spot, staying on the spot (standing by), performing a predetermined technique (punching, kicking, an electric shock, other techniques and actions peculiar to the character, and the like), and pausing a command once. Note that commands “the staying on the spot” may be a command immediately before arrival at the predetermined virtual unit space or a command (that is, a “pause” command) for maintaining details of a command immediately before the character reaches the predetermined virtual unit space such as a command for maintaining the character sitting, a command for maintaining the character standing, a command for maintaining the character sleeping, a command for maintaining the character flying in the virtual unit space, or the like.

In addition, the command can also include a command for generating a derived object caused by the existence, technique, or the like of the character in another virtual unit space adjacent to a virtual unit space which is the existence position of the character. For example, it is assumed that the character has a technique of “blowing off fire” as a predetermined technique. In this case, the command for generating a derived object is a command for generating a derived object representing “blowing off fire” in another virtual unit space adjacent to a predetermined virtual unit space in a case in which the character is positioned in the virtual unit space of concern and activates a “blowing off fire” technique.

Further, the command may be a command for changing the character to a predetermined character (hereinafter referred to as “evolution”) in a case in which the character satisfies predetermined conditions. Note that the “evolution” indicates that one character changes to another character which is an evolution destination in a case in which predetermined conditions are satisfied.

### (Storage Unit 22: Character Interference Information Storing Unit 223)

The character interference information storing unit 223 stores operation information indicating an operation of one character and/or another character in a case in which the one character has interfered with the other character. That is, the character interference information storing unit 223 stores operation information of an operation executed by one character and/or another character in a case in which the one character and the other character exist in the same virtual unit space. In addition, the operation information stored by the character interference information storing unit 223 may be operation information that is executed in a case in which a position of another character inside the virtual space 100 with respect to a position of one character inside the virtual space 100 satisfies a predetermined positional relation regardless of whether or not a user holding the one character and a user holding the other character are the same. For example, the predetermined positional relation is a relation in which a plurality of characters are positioned in the same virtual unit space, a relation in which a distance between one character and another character inside the virtual space 100 is a predetermined distance or less, or the like.

More specifically, the character interference information storing unit 223 stores operation information in association with one character ID used for identifying one character and another character ID used for identifying another character. In addition, the character interference information storing unit 223 may store operation information in association with one character ID and another character ID, command information representing a command before (e.g., immediately before) this one character being present together with another character in the same virtual unit space (hereinafter, referred to as “command information immediately before one character) and/or command information representing a command before (e.g., immediately before) this another character being present together with one character in the same virtual unit space (hereinafter, referred to as “immediately-before command information of another character”).

The operation information is set in accordance with, for example, a combination of one character and another character, a combination of character information of the one character and character information of the other character, or the like. In addition, the operation information can also be set in accordance with a command executed until one character reaches the same virtual unit space as another character, or a command executed immediately before one character reaches the same virtual unit space.

Note that the character interference information storing unit 223 can also store default operation information in association with information that characterizes a character (for example, the attributes, size, weight, and the like of the character). That is, the character interference information storing unit 223 can also store operation information without being associated with one character ID and another character ID. For example, in a case in which there are a plurality of characters and a plurality of commands, operation information may not be able to be set for all of combinations of the characters and/or combinations of the commands. In this case, the character interference information storing unit 223 stores default operation information in association with, for example, the same points and differences that can be ascertained by comparing features of one character with features of another character. Examples of the default operation information include information or the like for setting an operation in which a character having a smaller size is bounced off by another character in a case in which one character and another character have different sizes, and both the characters collide with each other in the same virtual unit space.

<Example of Operation Information Based on Type of Character: Case in which Types are the Same>

For example, operation information determined based on the type of one character and the type of another character will be described. First, in a case in which the type of one character and the type of another character are the same, and the one character and the other character exist in the same virtual unit space, operation information can be set based on a previous command of the one character and a previous command of the other character.

For example, in a case in which the previous command of one character is “move forward”, and the previous command of another character is also “move forward”, as the operation information, operation information representing an operation in which one character and another character “collide” with each other in the same virtual unit space, and both the one character and the other character are retreated to a virtual unit space in which the characters has been present immediately before can be set. In addition, in a case in which the previous command of the one character is “jump forward”, and the previous command of the other character is “stopping” (here, it is assumed that the one character “jumps forward” to reach a virtual unit space in which the other character is “stopping”), as the operation information, information representing an operation in which the one character and the other character overlap each other in the same virtual unit space, that is, an operation in which the one character gets on the other character can be set.

Furthermore, in a case in which the previous command of one character is “move forward”, another character is turning its back on the one character in a predetermined virtual unit space, and the previous command of the other character is “stopping” (note that it is assumed that the one character “moves forward” to arrive at a predetermined virtual unit space in which the other character is “stopping”), as the operation information, information representing an operation in which the other character is pushed out to another virtual unit space adjacent to a predetermined virtual unit space in a moving direction of the one character.

<Example of Operation Information Based on Type of Character: Case in which Types are the Same, and Size is Equal to or Greater than Predetermined Size>

Note that, even when the types of characters are the same, special operation information can also be set in accordance with the features of the characters, unlike the above description. For example, in a case in which the type of one character and the type of another character are the same, the sizes and/or weights of both the characters are equal to or greater than a predetermined value, and the one character and the other character exist in the same virtual unit space, predetermined operation information can be set based on a previous command of the one character and a previous command of the other character.

For example, in a case in which the previous command of one character is “jump forward”, and the previous command of another character is “stopping” (here, it is assumed that the one character “jumps forward” to arrive at a virtual unit space in which the other character is “stopping”), as the operation information, information representing an operation in which the one character “collides” with the other character in the same virtual unit space, and the one character stands in a virtual unit space in which the character has been present immediately before, rather than a case in which the one character gets on the other character unlike the above description because the sizes of both the characters are equal to or greater than a predetermined value (the one character cannot jump high) can be set.

<Example of Operation Information Based on Type of Character: Case in which Types are Different from Each Other (Part 1)>

In a case in which the type of one character and the type of another character are different from each other, and the one character and the other character exist in the same virtual unit space, operation information can be set based on features of the one character, features of the other character, a previous command of the one character, and a previous command of the other character.

For example, in a case in which the weight of one character is set as the features of the one character, the weight of another character is set as the features of the other character, and the weight of the one character is smaller than the weight of the other character, and in a case in which the previous command of the one character is “move forward”, and the previous command of the other character is also “move forward”, it is possible to set information as operation information, the information indicating an operation in which the one character and the other character collide with each other in the same virtual unit space (a virtual unit space which is a collision position), and the one character is retreated to a virtual unit space in which the character has existed immediately before, and an operation in which the other character stays in the virtual unit space which is a collision position.

<Example of Operation Information Based on Type of Character: Case in which Types are Different from Each Other (Part 2)>

In a case in which the type of one character and the type of another character are different from each other, and the one character and the other character exist in the same virtual unit space, operation information can be set based on special features of the one character.

For example, description will be given of a case in which one character has a feature that the character has ability to be able to copy features of another character existing in a virtual unit space positioned in front of the one character, the virtual unit space being adjacent to a virtual unit space in which the character exists. In this case, when the previous command of one character is “move forward”, and the previous command of another character is “stopping” or has details that a predetermined operation is executed on the spot, it is possible to set information as operation information, the information indicating an operation in which the one character moves forward after copying the ability of the other character and collides with the other character because the other character is positioned in front of the one character. In this case, as the operation information, information indicating the other character's surprise operation may be set at the same time.

### <Example of Operation Information Based on Size of Character>

For example, a case in which the size of one character and the size of another character are different from each other will be described. Here, it is assumed that the size of the one character is smaller than the size of the other character. In this case, as operation information, an operation when the one character has reached a virtual unit space in which the other character exists is set. This operation may be, for example, an operation in which the one character collides with the other character and bounces back in the opposite direction in a path where the one character has reached the virtual unit space of concern.

### <Example of Operation Information Based on Previous Command of Character (Part 1)>

In addition, description will be given of a case in which the type of one character and the type of another character are different from each other, the size of the one character and the size of the other character are different from each other, and the one character can be evolved. Here, it is assumed that the size of the one character is smaller than the size of the other character. Further, in a case in which one character and another character exist in the same virtual unit space, operation information can be set based on a previous command of the one character and a previous command of the other character.

For example, in a case in which a previous command when one character that has not been evolved reaches a predetermined virtual unit space is “move forward”, and a previous command of another character is “sleeping” in the predetermined virtual unit space, it is possible to set an operation in which the one character collides with the other character and bounces back in the opposite direction in a path where the one character has reached the virtual unit space of concern, and set an operation in which the other character continues to “sleep” as it is, as operation information.

On the other hand, for example, in a case in which one character satisfies predetermined conditions before reaching a predetermined virtual unit space to be “evolved”, a previous command of the one character after the evolution is “move forward”, and a previous command of another character is “sleeping”, it is possible to set an information as operation information, the information indicating an operation in which the one character collides with the other character in the same virtual unit space (a virtual unit space which is a collision position), the other character is “awake”, and the one character and the other character are stopped in the state of remaining awake together in the virtual unit space which is a collision position.

### <Example of Operation Information Based on Previous Command of Character (Part 2)>

In addition, description will be given of a case in which the type of one character and the type of another character are different from each other, the size of the one character and the size of the other character are different from each other, and the size of the one character is smaller than the size of the other character. Further, it is assumed that the one character exists in a virtual unit space above a virtual unit space in which the other character exists.

Here, in a case in which a previous command when the one character arrives at a predetermined virtual unit space in which the other character is present is “falling” or the like (or when there is no object or the like that interrupts the falling of a character above the predetermined virtual unit space, the one character may fall toward the predetermined virtual unit space with any command), and a previous command of the other character is “staying” in the predetermined virtual unit space, as the operation information, information representing an operation in which the one character collides with the other character and lands in a virtual unit space adjacent to this virtual unit space while bouncing can be set. On the other hand, in a case in which the one character has reached a predetermined virtual unit space along the same plane as the predetermined virtual unit space in which the other character exists, it is possible to set information as operation information, the information indicating an operation in which the one character collides with the other character and bounces back in a direction opposite to a moving direction.

In addition, description will be given of a case in which the type of the one character and the type of the other character are different from each other, and the one character can use a predetermined technique (for example, an electric shock).

Here, in a case in which a previous command in a case in which the one character reaches a predetermined virtual unit space in which the other character exists is “move forward”, a command for activating an “electric shock” after “move forward” is set, and a previous command of the other character is “sleeping” in the predetermined virtual unit space, it is possible to set information as operation information, the information indicating an operation in which the one character activates an “electric shock” when colliding with the other character, and the other character is surprised by an “electric shock” and jump up.

### (Storage Unit 22: Space Interference Information Storing Unit 224)

The space interference information storing unit 224 stores operation information indicating an operation of one character in a case in which the one character has interfered with a virtual unit space. That is, the space interference information storing unit 224 stores operation information of an operation executed by the one character in a case in which the one character exists in a predetermined virtual unit space. Note that the operation information also includes information for changing the state of a virtual unit space in which the one character exists by the interference of the one character.

More specifically, the space interference information storing unit 224 stores operation information in association with a character ID and a virtual unit space ID used for identifying a predetermined virtual unit space. In addition, the space interference information storing unit 224 may store operation information in association with a character ID, a virtual unit space ID, and command information (hereinafter referred to as “previous command information of a character”) representing a command before (e.g., immediately before) the character is present in a virtual unit space identified by the virtual unit space ID of concern.

The operation information is set by, for example, a combination of features of a character, or the like and virtual unit space information, or the like. In addition, the operation information can also be set by a command executed until the character reaches a predetermined virtual unit space, or a command executed immediately before the character reaches the predetermined virtual unit space.

### <Example of Operation Information Based on Terrain of Virtual Unit Space>

For example, a case in which a character has reached a virtual unit space of a predetermined terrain will be described. As an example, description will be given of a case in which a virtual unit space has a terrain of a “river”, and a character has reached the virtual unit space of concern in which the character has a “river” in accordance with a command set by the command setting unit 14.

Here, in a case in which a previous command of the character is “move forward”, and the attribute of the character is a “water type”, it is possible to set information as operation information, the information indicating an operation in which the character moves in a virtual unit space having a “river” similarly to a virtual unit space that does not have a “river”. Further, in a case in which a previous command of the character is “move forward”, the attribute of the character is a “water type”, and the character is a character that can swim in the water, it is possible to set information as operation information, the information indicating an operation in which the character swims in a “river” in a virtual unit space having a “river”. On the other hand, in a case in which a previous command of a character is “move forward”, and the attribute of the character is a “flame type”, it is possible to set information as operation information, the information indicating an operation in which the character cannot move to a virtual unit space having a “river” and is retreated. Further, in a case in which a previous command of a character is “move forward”, and the attribute of the character is a “rock type”, information indicating an operation in which the character is swept by a “river” and moves to another virtual unit space adjacent to the virtual unit space having a “river” may be set as operation information. Further, in a case in which a previous command of a character is “move forward”, the attribute of the character is a “rock type”, and the size of the character is equal to or greater than a predetermined size, information indicating an operation in which the character fits in the “river” and information that outputs how water overflows from the “river” may be set as operation information.

### <Example of Operation Information Based on Weather of Virtual Unit Space>

For example, a case in which the character has reached and/or exists in a virtual unit space of a predetermined weather will be described. As an example, description will be given of an example in which the weather in a virtual unit space is “rainy weather”, and a character reaches the virtual unit space of concern in accordance with a command that is set by the command setting unit 14.

Here, in a case in which a previous command of the character and/or a command in the virtual unit space of “rainy weather” is “running and moving by one square”, it is possible to set information as operation information, the information indicating an operation in which the character slips and moves one or more extra squares with a predetermined probability (for example, randomly) in a case in which the character moves through the virtual unit space of “rainy weather”. Further, in a case in which a previous command of the character and/or a command in the virtual unit space of “rainy weather” is a “weather changing technique”, it is also possible to set information as operation information, the information indicating that the weather of the virtual unit space in which the character exists is changed using the technique.

### <Example of Operation Information Based on Virtual Unit Space and Attribute of Character>

For example, a case in which a character has reached a virtual unit space of a predetermined terrain will be described. As an example, description will be given of an example in which a virtual unit space has a terrain of a “wall”, and a character has reached the virtual unit space of concern having a “wall” in accordance with a command set by the command setting unit 14.

Here, in a case in which a previous command of the character is “move forward”, and the attribute of the character is a “normal type”, it is possible to set information as operation information, the information indicating an operation in which the character cannot move through a virtual unit space having a “wall” and stays in a virtual unit space immediately before reaching the virtual unit space of concern. Further, in a case in which a previous command of the character is “move forward”, and the attribute of the character is a “ghost type”, it is possible to set information as operation information, the information indicating an operation in which the character passes through the virtual unit space having a “wall” and moves.

### (Storage Unit 22: Object Information Storing Unit 225)

The object information storing unit 225 stores information regarding an object that can be disposed in a virtual unit space (object information). Specifically, the object information storing unit 225 stores the object information and the like in association with an object ID for identifying the object. The object information is information indicating, for example, the attribute of the object, the type of the object, the name of the object, the size of the object, whether the object can be destroyed, and the like. Note that the attribute is information which is set for each object, and is the features of the object which are set in accordance with, for example, the type, state, properties, or the like of the object. Note that a plurality of attributes may be set for one object.

In addition, the object is an object that can be disposed in a virtual unit space and can include an object for which an environment such as the terrain of the virtual unit space can be set or deformed (hereinafter referred to as an “environment object”). The environment object may include objects representing a terrain (for example, trees, rocks, the sea, a waterfall, rivers, and the like), objects representing structures (for example, blocks, walls, buildings, floors, and the like), and/or a character for which a command cannot be set by the command setting unit 14 (for example, a character that is sleeping in a predetermined virtual unit space or is not moving even when the character is awake, or the like), and the like. In addition, the environment object may include an object that can be interfered with by a character and an object that cannot be interfered with by a character. The object that can be interfered with by a character is an object (for example, a tree, a rock, or the like that can be destroyed) that can be destroyed by an operation (for example, a predetermined technique, a rush, or the like) of the character. On the other hand, the object that cannot be interfered with by a character is an object (for example, a floor, a wall, or the like that cannot be destroyed) that cannot be destroyed by an operation of the character. Furthermore, the object may include a derived object specific to a predetermined character. The derived object is, for example, an object that is generated in accordance with the activation of an operation of a predetermined character (as an example, a technique of the predetermined character).

### (Storage Unit 22: Object Interference Information Storing Unit 226)

The object interference information storing unit 226 stores operation information indicating an operation of a character and/or an object in a case in which the character has interfered with the object. That is, the object interference information storing unit 226 stores operation information regarding an operation executed by the character and/or influence received by the object in a case in which the character and the object exist in the same virtual unit space.

More specifically, the object interference information storing unit 226 stores operation information in association with a character ID and an object ID. In addition, the object interference information storing unit 226 may store operation information in association with the character ID, the object ID, and command information (hereinafter referred to as “previous command information of a character”) representing a command before (e.g., immediately before) the character is present in the same virtual unit space as the object.

The operation information is set by, for example, a combination of the character and the object, a combination of character information of the character and object information of the object, or the like. In addition, the operation information can also be set in accordance with a command executed until the character reaches the same virtual unit space as the object, or a command executed immediately before the character reaches the same virtual unit space.

### <Example of Operation Information Based on Type of Object>

For example, a case in which a character has reached a virtual unit space in which a predetermined object is disposed will be described.

As an example, it is assumed that an environment object representing a “rock” is disposed in a virtual unit space, and the environment object is an object that can be interfered with. Further, in a case in which a character has reached the virtual unit space, a previous command of the character is “activation of technique”, and an environment object which is a “rock” can be destroyed in the technique, it is possible to set information as operation information, the information indicating an operation in which the character destroys the “rock” using a “technique”. In addition, it is assumed that an environment object representing a “rock” is disposed in a virtual unit space, and the “rock” is an object that cannot be interfered with by the environment object. Further, even when a previous command of the character is any command in a case in which the character has reached the virtual unit space, it is possible to set information as operation information, the information indicating an operation in which the character bounces back by the “rock” and is retreated to a virtual unit space immediately before the character reaches the virtual unit space of concern.

In addition, as an object, an object that can be evolved by a predetermined character acquiring the object can be prepared. For example, the disposition unit 12 disposes an object (an object for evolution) required for evolution of a predetermined character in a predetermined virtual unit space. Further, even when a previous command of the character is any command in a case in which the predetermined character has reached the virtual unit space in which the object for evolution is disposed, in accordance with a command set by the command setting unit 14, information indicating an operation in which the character is evolved can be set as operation information.

### (Storage Unit 22: Operation Sequence Information Storing Unit 227)

The operation sequence information storing unit 227 stores operation sequence information in association with an operation sequence information ID for identifying the operation sequence information. The operation sequence information is information including a virtual space 100 used for an operation of a character, disposition results obtained by the disposition unit 12, one or more commands and the execution order of the commands which are set for a predetermined character by the command setting unit 14, and an operation of the character which is controlled by the operation control unit 18 to be described later. That is, the operation sequence information is information making it possible to reproduce the disposition of a character and/or an object in the virtual space 100, and a series of operations from when an operation of the character is started to when the operation is terminated in the virtual space 100 at any timing in any system including the simulation system 1.

The output unit 20 can execute an operation of the character in the virtual space 100 at an arbitrary timing based on the operation sequence information, and typically can reproduce the operation of the character in the virtual space 100 as a moving image on a display part or the like of an information terminal of each user in response to a user's instruction. The operation sequence information may be provided to, for example, an information terminal, a server, or the like outside the simulation system 1 in which the operation sequence information is generated, through a communication network, a storage medium, or the like. The information terminal, the server, or the like to which the operation sequence information is provided can execute the operation of the character in the virtual space 100 using the operation sequence information. In accordance with this, the operation sequence information created by one simulation system 1 can be supplied to another simulation system 1.

### (Storage Unit 22: User Information Storing Unit 228)

The user information storing unit 228 stores user information, character information, object information, and area information in association with a user ID used for identifying a user. The user information is a user name, a nick name of a user, information of the user specific to the individual (date of birth and the like), information relating to a target achieved by the user in the simulation system 1 and/or information relating to an item held by the user, and the like. In addition, the character information is information relating to characters owned by a user (for example, information of a character ID, the number of held characters, and the like), and the object information is information relating to objects owned by a user (for example, information of an object ID, the number of objects, and the like). Furthermore, the area information is information relating to an area associated with a user (for example, information of an area ID and the like).

### (Disposition Unit 12)

The disposition unit 12 disposes a character and/or an object in the virtual unit space 110 constituting the virtual space 100. The disposition unit 12 can also dispose a character and/or an object in the virtual unit space 110 in advance. In addition, the disposition unit 12 can dispose a predetermined character and/or a predetermined object in the virtual unit space 110 designated by a user in response to the user's instruction received by the input unit 10. The disposition unit 12 can also dispose a character and/or an object in each of the plurality of virtual unit spaces 110. That is, the disposition unit 12 can dispose one or more characters in each of one or more virtual unit spaces 110 and/or can dispose one or more objects in each of one or more virtual unit spaces 110 on the basis of an instruction from each user. Note that, since the virtual space 100 is configured to have a virtual three-dimensional structure, the disposition unit 12 can also dispose a character and/or an object not only on the lower surface 102 of the virtual space 100 but also in the virtual unit space 110 above the lower surface 102.

Here, the disposition unit 12 limits the position of a character disposed first in an area on the basis of an area associated with a user. More specifically, when designating an operation start position that is a position inside an area in which one character (a first character) of one user (a first user) starts an operation, the disposition unit 12 permits designation of an operation start position of one character inside one area (a first area) associated with one user and prohibits designation of an operation start position of one character in another area not associated with the one user. The disposition unit 12 similarly operates also for another user (a second user). In addition, the disposition unit 12 permits installation of an object owned by one user inside one area associated with the one user and prohibits installation of an object inside another area (a second area) not associated with the one user. The disposition unit 12 similarly operates also for other users.

Furthermore, the output unit 20 outputs information of a character which is stored in the character information storing unit 220 and/or an object which is stored in the object information storing unit 225 (for example, list information of characters and/or objects which can be used in the simulation system 1 by the one user) to a display unit of the information terminal of the one user using the character information stored in the user information storing unit 228 in association with a user ID of the one user and/or a character ID and/or an object ID included in the object information. Then, the disposition unit 12 receives an instruction for selecting a character and/or an object from one user through the input unit 10 to acquire information of a character, which is selected by the one user, which is stored in the character information storing unit 220 and/or information of an object, which is selected by the one user, which is stored in the object information storing unit 225. In addition, the output unit 20 outputs the virtual space 100 formed from the virtual unit space 110 to a display unit of the information terminal of the one user. The disposition unit 12 receives the selection instruction of the virtual unit space 110 from the one user through the input unit 10 for each character and/or object selected by the one user. Then, the disposition unit 12 disposes the character represented by the acquired information of the character and/or the object represented by the acquired information of the object in the virtual unit space that has been instructed to be selected by the one user. The output unit 20 of the information terminal of the one user can output an image representing a state in which the disposition unit 12 disposes the character and/or the object in the virtual unit space. The disposition unit 12 supplies information on the character and/or the object disposed in the virtual space 100 to the operation control unit 18.

### (Command Setting Unit 14)

The command setting unit 14 sets one or more commands executed inside the virtual space 100 by a character owned by each of a plurality of users for each character and, in a case in which a plurality of commands are set, sets an execution order of the plurality of commands in each character. In other words, the command setting unit 14, for each of one or more characters, can set commands and an execution order on the basis of an instruction of each user having each character. More specifically, the command setting unit 14, for one character owned by one user, can set commands and an execution order on the basis of an instruction from one user, that is, one operation of the one user (for example, an instruction of command setting received through the input unit 10) and, for other characters owned by other users, can set commands and an execution order on the basis of an instruction from another user.

In addition, a user “owns” a character, for example, includes the following forms.
(a) A character is associated with a user, and a command can be set in the character by a user.
(b) A character constantly owned by a user through a lottery, purchase, or the like or a character that is temporally owned (in other words, not owned after elapse of a predetermined time).
(c) A character of which a right to be used in a game is temporarily rented from another player (for example, a friend of a user, a member of a team to which a user belongs, or the like) having a predetermined relation with a user.

In addition, after one character moves from an operation start position of one area to another area on the basis of commands set by one user, the command setting unit 14 also can set (that is, additionally set or newly set) commands and an execution order in one character inside another area on the basis of an instruction from one user received through the input unit 10. In other words, although a character of one user can be initially disposed in one area associated with the one user, and commands and an execution order of the commands can be set at that position, commands and an execution order of the commands cannot be set by initially disposing the character in another area. However, after one character penetrates into the inside of another area from one area on the basis of set commands, for the one character present inside the other area, a change of the commands, a new command, and an execution order of the commands can be set.

In a case in which a plurality of characters are selected by one user, the command setting unit 14 sets commands and an execution order for each of one character and other characters other than the one character. In other words, the command setting unit 14 receives selection of commands performed by one user and an execution order of the selected commands through the input unit 10 and associates the commands and the execution order of the commands that have been received with a character selected by the one user. Similarly, the command setting unit 14 associates commands and an execution order of the commands with one or more characters owned by another user in accordance with an instruction from another user. Specifically, the output unit 20 outputs information regarding a command for a character which is stored in the command information storing unit 222 so that the user can perceive the information. In addition, the command setting unit 14 receives an instruction for setting commands and the execution order of the commands by the user referring to the information on the command through the input unit 10, and associates the received commands and the execution order of the commands with the character selected by the user. In addition, the output unit 20 can output the commands and the execution order of the commands which are set by the command setting unit 14 so that the information terminal of each user can perceive them using text, a predetermined figure, or the like. The command setting unit 14 supplies information representing the commands and the execution order of the commands which are associated with a character of each of a plurality of users to the operation control unit 18.

Note that the command setting unit 14 can also automatically set commands and the execution order of the commands without receiving commands selected by the user and the user's instruction for the execution order of the commands. In this case, for example, the command setting unit 14 can also randomly set commands and the execution order of the commands and can also set predetermined commands and the execution order of the commands. As an example, the command setting unit 14 may set predetermined commands and the execution order of the commands in a predetermined character as a tutorial.

Specifically, the command set by the command setting unit 14 is a command which is stored in the command information storing unit 222. Examples of the command set by the command setting unit 14 include the above-described first operation command and second operation command, a repetition operation command, a command for generating a derived object, a command for performing evolution, and the like. Note that the command setting unit 14 can set the amount of movement from a predetermined virtual unit space included in the first operation command with the number of virtual unit spaces as a unit. That is, it is possible to set a command such as “moving forward by two squares” for a character by treating the virtual unit space as a virtual square. It becomes easy to set the movement of a character by treating a virtual unit space as a virtual square. In addition, the execution order of the command set by the command setting unit 14 can be freely set in accordance with a user's desire.

Furthermore, the number of commands and/or types of command that can be set in a character may be different in accordance with the character. The command setting unit 14 can limit the number of commands that can be set in a character on the basis of “a maximum number of commands that can be accepted by a character in one instruction” included in the character information stored in the character information storing unit 220. In addition, the command setting unit 14 may limit types of command that can be set in a character on the basis of “types of commands that can be accepted by a character” included in the character information stored in the character information storing unit 220. For example, in a case in which a first character and a second character are present, and a size of the first character is smaller than a size of the second character, small rotation is effective for the first character, and thus a maximum number of commands of the first character may be set to be larger than a maximum number of commands of the second character. In addition, in a case in which the size of the first character is smaller than a predetermined size, and the size of the second character is equal to or larger than the predetermined size, the first character is light, and thus “jump” may be included in the type of commands for the first character, and “jump” may not be included in the type of commands for the second character.

<Example of Command Including Case in which Character is Evolved During Operation in Virtual Space 100>

Here, a case in which the command setting unit 14 sets a command for “evolution” for one character is described as an example. For example, it is assumed that the command setting unit 14 has set commands of “move forward”, “activation of technique”, “move forward”, “evolution”, “move forward”, and “activation of technique” in this order for one character. In this case, the command setting unit 14 may make a command of “activation of technique” before evolution and a command of “activation of technique” after evolution different depending on before and after the evolution of a character. That is, the user may not only simply set a command of “activation of technique” but also appropriately set the content of a “technique” based on the contents of commands and the execution order of the commands which are set by the command setting unit 14. In this example, it is assumed that the technique of the character before evolution and the technique of the character after evolution are different. For this reason, in a case in which the user sets a command of “activation of technique” for the character after evolution, the command setting unit 14 determines that the “technique” is the “technique” of the character after evolution, and may perform setting so that the “technique” of the character after evolution is activated instead of the “technique” of the character before evolution.

### (Execution Reception Unit 16)

The execution reception unit 16 receives an instruction for executing a command set by the command setting unit 14. Specifically, the execution reception unit 16 receives the instruction for executing a command from a user through the input unit 10. In a case in which the user sets a command for a plurality of characters, the execution reception unit 16 can receive the execution of the command in accordance with, for example, any one of the following patterns.

(Pattern 1) Instructions for executing commands for all of a plurality of characters are collectively received.

(Pattern 2) A plurality of characters are divided into a plurality of groups, and an instruction of executing a command is received at a different timing for each of the groups or at the same timing for some of the groups.

(Pattern 3) An instruction for executing a command is received for each character selected from among a plurality of characters by a user.

The execution reception unit 16 supplies information indicating that an instruction for executing a command for a predetermined character has been received to the operation control unit 18.

### (Operation Control Unit 18)

The operation control unit 18 operates a character disposed in the virtual space 100 by the disposition unit 12 inside the virtual space 100 on the basis of commands and an execution order set by the command setting unit 14 in accordance with information received from the execution reception unit 16. The operation control unit 18 can operate each of a plurality of characters in real time or for every predetermined number of turns inside the virtual space 100. For example, the operation control unit 18 receives an instruction from one user and operates one character owned by one user inside the virtual space 100 on the basis of commands and an execution order set for the one character regardless of an instruction from another user, and receives an instruction from another user and operates another character owned by the other user inside the virtual space 100 on the basis of commands and an execution order set for the other character regardless of the instruction from the one user. Then, the operation control unit 18 operates a plurality of characters inside the virtual space 100 in real-time by being triggered upon reception of an execution instruction of a command for each of a plurality of characters. The operation control unit 18 can advance a time of the inside of the virtual space 100 in real time.

In other words, the operation control unit 18 receives an instruction of execution and an instruction of stopping of a command set in a character owned by each of a plurality of users for each of a plurality of users or for each of characters of the plurality of users and executes the command or stops the command at a timing at which the instruction of execution or the instruction of stopping of the command is received.

For example, the operation control unit 18 outputs a “play button” receiving an execution instruction of a command according to a user and a “stop button” receiving a stop instruction of a command according to a user to each output unit 20 by controlling the output unit 20 of the information terminal of each user. Then, the operation control unit 18 operates one character inside the virtual space 100 on the basis of commands and an execution order set for the one character in accordance with a start instruction received from one user through the “play button”. In addition, the operation control unit 18 operates another character inside the virtual space 100 on the basis of commands and an execution order set for the other character in accordance with a start instruction received from another user through the “play button”. In other words, in a case in which a start instruction is received from one user, the operation control unit 18 operates one character inside the virtual space 100 regardless of presence/absence of a start instruction from another user (that is, regardless of a start instruction of another user). In addition, in a case in which a start instruction from another user has been received, the operation control unit 18 operates another character inside the virtual space 100 regardless of presence/absence of a start instruction from the one user (that is, regardless of a start instruction from the one user).

Then, the operation control unit 18 stops the operation of one character that has been operating inside the virtual space 100 regardless of presence/absence of a stop instruction from another user in accordance with a stop instruction received from one user through the “stop button” and stops the operation of another character that has been operating inside the virtual space 100 regardless of presence/absence of a stop instruction from one user in accordance with a stop instruction received from another user through the “stop button”. In this case, the command setting unit 14 may receive settings of a new command and an execution order instead of commands and an execution order set in the stopped character. In other words, each user sets commands and an execution order of the commands in his or her character, and before completion of execution of all the set commands after the character is caused to start execution of the commands, the user can change the set commands once after stopping execution of the commands regardless of operations of users different from him or her.

In addition, in a case in which commands and an execution order of the commands are set in each of a plurality of characters owned by one user, the operation control unit 18 can cause each of a plurality of characters to start execution of commands according to the execution order of the commands in accordance with one operation of one user (for example, an instruction of command execution received through the input unit 10).

Furthermore, in a case in which a positional relation of another character (a second character) owned by another user with respect to one character (a first character) owned by one user inside of the virtual space 100 satisfies a predetermined condition, the operation control unit 18 causes at least one of the one character and the other character to execute a predetermined operation with preference over an operation based on commands set in one character by the command setting unit 14 and commands set in another character. In other words, a predetermined operation different commands set in one character and commands set in another character is executed. Examples of the predetermined condition include conditions such as a case in which a presence position of one character and a presence position of another character overlap each other, a case in which a presence position of one character and a presence position of another character approach each other (for example, a case in which a virtual unit space in which one character is present and a virtual unit space in which another character are adjacent to each other or a case in which the number of virtual unit spaces between one character and another character is a predetermined value or less, or the like), and the like.

In addition, in a case in which an interference has occurred in the virtual space 100 between another character other than one character, an object disposed in a predetermined virtual unit space (an object owned by one user and/or an object owned by another user), and/or the predetermined virtual unit space, and one character in which the execution of a command has been started, the operation control unit 18 causes the one character to execute an operation according to the interference with preference over the commands and the execution order of the commands set by the command setting unit 14. In other words, in this case, the operation control unit 18 can determine an operation to be executed by the one character in compliance with a rule set in advance. In addition, the operation control unit 18 outputs the appearance of the one character that is in the middle of execution of a command to the output unit 20.

Furthermore, after execution of all the commands is completed by causing a character in which commands and an execution order of the commands are set to operate inside the virtual space 100, the operation control unit 18 may prohibit setting of commands and an execution order of the commands for this character that is performed by the command setting unit 14 for a predetermined period. In this case, the operation control unit 18 can shorten or lengthen the length of this predetermined period in accordance with an instruction of consumption of a predetermined item (for example, virtual currency of the inside of a game, a tool that can be acquired inside a game, and the like) from a user having this character received through the input unit 10.

Note that, in a case in which a command set by the command setting unit 14 cannot be executed due to a relation between a character and a virtual space in which the character exists, the operation control unit 18 can also cause the character to execute a predetermined operation. For example, in a case in which the character is disposed in the air of the virtual space 100 by the disposition unit 12, the character is a character that cannot fly or float in the air, and the command set by the command setting unit 14 is a movement command such as “move forward”, the operation control unit 18 determines that the movement command cannot be executed. In addition, the operation control unit 18 stops the execution of the movement command and operates the character in accordance with, for example, physical laws (in this case, a character is dropped downward from the existence position of the character). Subsequently, the operation control unit 18 continues executing the command set by the command setting unit 14 at a stage where the command set by the command setting unit 14 can be executed (in this case, at a stage where the character has landed on the floor in the virtual space).

Here, in a case in which a character is moved inside the virtual space 100 on the basis of the commands and the execution order of the commands which are set by the command setting unit 14, the operation control unit 18 moves the character from one virtual unit space to another virtual unit space adjacent to the one virtual unit space. When a virtual unit space is perceived as a “square”, the operation control unit 18 moves a character for each “square”. In addition, the operation control unit 18 may move a character for each predetermined time. In other words, the operation control unit 18 may seamlessly move the character over a plurality of virtual unit spaces for each predetermined period of time (as an example, it is possible to perform setting for moving one virtual unit space per second or the like). In addition, in a case in which a character is moved inside the virtual space 100 after execution of commands set by the command setting unit 14, even when there is an instruction for movement of this character from one virtual unit space to another virtual unit space (for example, an instruction for movement through dragging) from a user through the input unit 10, the operation control unit 18 causes the character to execute an operation according to commands and an execution order of the commands that have been set without accepting this instruction for movement.

In addition, in a case in which another character of another user is controlled by the operation control unit 18 to penetrate and be present inside one area of one user, the disposition unit 12 can dispose a character or an object owned by him or her in a virtual unit space in which the other character is present on the basis of an instruction from the one user. In this case, the disposition unit 12 can dispose the character or the object on or under another character.

Note that, in a case in which interference has occurred between a character, which operates based on the commands and the execution order of the commands which are set by the command setting unit 14, and another character or an object and in a case in which interference has occurred between a character, which operates based on the commands and the execution order of the commands, and a predetermined virtual unit space, the operation control unit 18 may control an operation of the character also using an operation determined based on physical arithmetic calculation. For example, in a case in which a character and another character or an object collide with each other, operations of the character and another character or the object may be calculated by physical arithmetic calculation based on the shape, size, weight, and the like of the character, the shape, size, weight, and the like of the other character, the speed of collision, and the like, and the character may be caused to execute the calculated operation.

Further, the operation control unit 18 generates operation sequence information indicating a series of operations (including an operation based on a command set by the command setting unit 14 and an operation in a case in which interference has occurred) of a character in the virtual space 100, and stores the generated operation sequence information in the operation sequence information storing unit 227 in association with an operation sequence information ID of the operation sequence information. Note that the operation control unit 18 can also generate operation sequence information indicating some of the series of operations of the character in the virtual space 100 as the operation sequence information. That is, the operation control unit 18 can generate operation sequence information including all or some of operations of the character based on the execution of a command according to the execution order of the command which is set by the command setting unit 14, and operations of the character in a case in which interference has occurred.

Specifically, the operation control unit 18 can control an operation of a character based on features of the character and features of a virtual unit space corresponding to the existence position of the character. As an example, the operation control unit 18 acquires operation information stored in the space interference information storing unit 224 in association with a character ID of a character that is executing a command and a virtual unit space ID of a virtual unit space in which the character exists. In addition, the operation control unit 18 causes the character to execute an operation indicated by the content of the operation information with reference to the acquired operation information. In addition, the operation control unit 18 may acquire operation information stored in the space interference information storing unit 224 in association with a character ID of a character that is executing a command, a virtual unit space ID of a virtual unit space in which the character exists, and a command executed immediately before the character reaches the virtual unit space of concern (previous command information), and may cause the character to execute a predetermined operation based on the operation information.

Further, in a case in which each of one character and another character is operated in the virtual space 100, and the existence position of the one character and the existence position of the other character are the same virtual unit space, the operation control unit 18 can cause at least one of the one character and the other character to execute a predetermined operation with preference over commands and the execution order of the commands which are set by the command setting unit 14. In this case, the operation control unit 18 can control an operation of at least any one of the one character and the other character based on at least one selected from a group consisting of a combination of features of the one character and features of the other character, a command executed before the one character and the other character are positioned in the same virtual unit space, and a command executed before the other character is positioned in the same virtual unit space as the one character.

For example, in a case in which one character and another character exist in the same virtual unit space, the operation control unit 18 causes the one character and/or the other character to execute an operation indicated by the content of operation information with reference to the operation information stored in the character interference information storing unit 223 in association with a character ID of one character that is executing a command and another character ID of the other character. In addition, the operation control unit 18 may acquire operation information stored in the character interference information storing unit 223 in association with one character ID of the one character that is executing a command and the other character ID of the other character, and a command executed immediately before the one character reaches a virtual unit space in which the character exists (previous command information of one character) and/or a command executed immediately before the other character reaches the virtual unit space of concern (previous command information of another character), and may cause the one character and/or the other character to execute a predetermined operation based on the operation information.

In addition, the operation control unit 18 can control an operation of a character based on features of a character and features of an object disposed at the existence position of the character. As an example, the operation control unit 18 acquires operation information stored in the object interference information storing unit 226 in association with a character ID of a character that is executing a command and an object ID of an object disposed in a virtual unit space in which the character exists. In addition, the operation control unit 18 causes a character to execute an operation indicated by the content of the operation information with reference to the acquired operation information. In addition, the operation control unit 18 may acquire operation information stored in the object interference information storing unit 226 in association with a character ID of a character that is executing a command, an object ID of an object disposed in a virtual unit space in which the character exists, and a command executed immediately before the character reaches the virtual unit space of concern (previous command information), and may cause the character to execute a predetermined operation based on the operation information.

Note that, in a case in which one character exists in one virtual unit space, and another character exists in another virtual unit space adjacent to the one virtual unit space and associated with the generation of a derived object, the operation control unit 18 can also control an operation of the other character based on features of the other character and features of the derived object. For example, in a case in which the other character exists in another virtual unit space adjacent to one virtual unit space in which the one character exists, and a command for the one character to execute a predetermined operation (for example, an operation that exerts a predetermined effect on another virtual unit space) in one virtual unit space is set by the command setting unit 14, the operation control unit 18 cause the other character to execute the predetermined operation. That is, the operation control unit 18 may acquire operation information stored in the object interference information storing unit 226 in association with another character ID and an object ID of the derived object, and may cause the other character to execute the predetermined operation based on the acquired operation information.

### Example 1 of Operation Based on Relation Between Derived Object and Character

For example, a case in which the command setting unit 14 sets a command for generating a derived object specific to one character in another virtual unit space adjacent to one virtual unit space for the one character in a case in which the one character has arrived at the one virtual unit space will be described as an example. Here, in a case in which the one character has reached one virtual unit space and the other character has reached another virtual unit space, the operation control unit 18 executes a predetermined operation with preference over a command set in the other character in accordance with the type of the other character and the type of derived object. That is, the operation control unit 18 acquires operation information stored in the object interference information storing unit 226 in association with another character ID of the other character and an object ID of the derived object disposed in a virtual unit space in which the other character exists. As an example, the operation information is information including a content that a derived object specific to one character is a derived object that represents an “electric shock” corresponding to an “electric shock” which is a technique of the one character, and another character executes an operation of being paralyzed by the derived object having been subjected to the “electric shock”. Thus, the operation control unit 18 causes the other character to execute a paralysis operation.

### Example 2 of Operation Based on Relation Between Derived Object and Object

For example, a case in which the command setting unit 14 sets a command for generating a derived object specific to one character in another virtual unit space adjacent to one virtual unit space for the one character in a case in which the one character has reached the one virtual unit space will be described as an example. Here, in a case in which the one character has reached the one virtual unit space, and a predetermined object exists in the other virtual unit space, the operation control unit 18 has a predetermined influence on a predetermined object in accordance with the type of predetermined object and the type of derived object.

In this case, the object interference information storing unit 226 can store operation information including the influence on the predetermined object in association with one character ID of the one character and an object ID of the derived object. In addition, the operation control unit 18 acquires the operation information stored in the object interference information storing unit 226. As an example, the operation information is information including a content that a derived object specific to one character is a derived object that represents “flame” corresponding to “blowing off fire” which is a technique of the one character, and the predetermined object burns with the derived object of “flame”. Thus, the operation control unit 18 generates a state where the predetermined object burns.

Further, in a case in which it is determined that a command set by the command setting unit 14 cannot be executed at the existence position of a character or in a virtual unit space which is a movement destination, the operation control unit 18 may execute a predetermined operation. For example, the character cannot be moved to the outside of the virtual space 100. That is, the outer edge of the virtual space 100 functions as an “invisible wall” or an “invisible floor or ceiling” for the character in the virtual space 100. Consequently, in a case in which the character moves in the virtual space 100 in accordance with a command set by the command setting unit 14, and a situation has occurred in which interference by the character is impossible such as a virtual unit space in which the outer edge of the virtual space 100 or an object that cannot be destroyed is disposed, the operation control unit 18 causes the character to execute a predetermined operation. Examples of the predetermined operation include an operation of staying on the spot, an operation of moving along a moving path in the opposite direction, an operation of changing a moving direction, and the like.

### (Determination Unit 26)

The determination unit 26 sets predetermined conditions that are the same or different from each other in a plurality of users and determines whether or not the predetermined conditions are satisfied as a result of an operation of each character of each user according to commands and an execution order of the commands that have been set inside the virtual space 100. The determination unit 26 displays the determination result in the output unit 20 of the information terminal of each user. In a case in which the predetermined conditions are satisfied, the determination unit 26 may generate a predetermined effect in each user. The predetermined effect, for example, is an effect of granting a predetermined reward to each user, an effect of granting a predetermined experience value and the like to a character of each user, and/or an effect of associating (or an effect of not associating) a user with a predetermined area in accordance with a degree of achievement of a target.

The predetermined conditions are conditions to be achieved inside a predetermined area. Examples of the predetermined conditions include the following conditions but are not limited to such conditions.
(1) A condition in which one character of one user arrives at a predetermined place of another area from one area (for example, a place at which a predetermined virtual unit space is set as a goal)
(2) A condition in which one character of one user attacks another character of another user to cause HP of another character to zero
(3) A condition in which the vicinity of another character of another user is surrounded using a predetermined object to cause movement of the other character inside the virtual space 100 to be impossible
(4) A condition in which a predetermined object is destroyed
(5) A condition in which penetration of another character of another user into the inside of one area of one user is protected for a predetermined time
(6) A condition in which one character of one user and another character of another user cooperate to destroy a predetermined object, or movement of a predetermined character, which is disposed in a predetermined area in advance and of which movement is restricted inside this area, is enabled to move

Hereinafter, a specific example will be described.

### Example 1 of Set Target: Cooperative Play 1

Cooperation of one character of one user and another character of another user to remove an object installed in a predetermined area of the inside of the virtual space 100 can be set as a target. For example, the disposition unit 12 installs an object in a predetermined area of the inside of the virtual space 100. This object is assumed to be an object “ice” (hereinafter, referred to as an “ice object”). Then, the object interference information storing unit 226 is assumed to store operation information including effects on the ice object in association with two or more predetermined character IDs and object IDs of two or more derived objects. Here, each of characters corresponding to two or more predetermined character IDs is assumed to have a technique relating to heat such as “flame”, “fire”, and the like. In this case, this operation information is information including contents indicating that a derived object of one character is a derived object representing “flame” corresponding to “blowing off fire” that is a technique of one character, a derived object of another character is a derived object representing “spark” corresponding to “spark” that is a technique of another character, and an ice object is melt in accordance with two or more derive objects of these “flame” and “spark”. In other words, as one example, in a case in which two or more derived objects representing a predetermined technique (for example, a “blowing off fire” technique, a “spark” technique, or the like) of two or more characters corresponding to two or more predetermined character IDs overlap with an ice object, this operation information is operation information indicating that the ice object is melt and disappears. Here, a character ID of one character and a character ID of another character are assumed to be included in two or more predetermined character IDs.

In this case, the disposition unit 12, first, disposes one character in a predetermined virtual unit space of one area in accordance with an instruction from one user (this disposition position will be referred to as “one operation start position”). Here, the one character has a “blowing off fire” technique. Next, the command setting unit 14 sets a command for moving from one operation start position to a virtual unit space adjacent to a virtual unit space in which the ice object is present and activating a technique for the ice object (that is, a command for generating a derived object that is specific to one character) in one character in accordance with an instruction from one user. Similarly, the disposition unit 12 disposes another character in a predetermined virtual unit space of another area in accordance with an instruction from another user (this disposition position will be referred to as “another operation start position”). This another character has a “spark” technique. Next, the command setting unit 14 sets a command for moving from another operation start position to a virtual unit space adjacent to a virtual unit space in which the ice object is present and putting a technique in the ice object (that is, a command for generating a derived object that is specific to the other character) in another character in accordance with an instruction from another user.

Then, the operation control unit 18 operates one character on the basis of commands and an execution order of the commands set in accordance with an instruction of command execution for the one character by the one user received through the execution reception unit 16. The operation control unit 18 similarly operates other characters as well. In a case in which one character has arrived at a virtual unit space adjacent to the ice object, the operation control unit 18 generates a derived object (for example, an object of the “blowing off fire” technique) of one character in the ice object. Furthermore, in a case in which another character has arrived at a virtual unit space adjacent to the ice object, the operation control unit 18 generates a derived object (for example, an object of the “spark” technique) of another character in the ice object.

In other words, the operation control unit 18 acquires operation information including effects on an ice object stored in the object interference information storing unit 226 in association with a character ID of one character, a character ID of another character, and an object ID of a derived object. Then, the operation control unit 18 causes the ice object to execute an operation in which the ice object is melt to disappear. The determination unit 26 determines whether or not the ice object has been removed from the virtual space 100 and, in a case in which it has been removed, generates a predetermined effect in each user (for example, a predetermined reward is granted to each user).

### Example 2 of Set Target: Cooperative Play 2

Cooperation of one character of one user and another character of another user and generation of a predetermined effect in a predetermined character installed in a predetermined area of the inside of the virtual space 100 can be set as a target. For example, the disposition unit 12 installs a predetermined character (hereinafter, referred to as a “target character”) in a predetermined area of the inside of the virtual space 100. The target character is a character that “evolves” in the presence of “water”. Then, the object interference information storing unit 226 is assumed to store operation information including an effect on a virtual unit space adjacent to a character in association with two or more predetermined character IDs and object IDs of two or more derived objects. Here, one character among characters corresponding to two or more predetermined character IDs is assumed to have a technique relating to heat such as “flame”, “fire”, and the like, and another character is assumed to have a technique relating to “ice” and the like. In this case, this operation information is information including details in which a derived object of one character is a derived object representing “flame” corresponding to “blowing off fire” that is a technique of one character, a derived object of another character is a derived object representing an “ice block” (or a snowstorm) corresponding to “ice” that is a technique of another character, and a target character evolves in accordance with water generated by a derived object of these “flame” and “ice block”. In other words, as one example, this operation information is operation information in which a target character evolves in a case in which two or more derived objects representing predetermined techniques (for example, a “blowing off fire” technique, an “ice” technique, and the like) of two or more characters corresponding to two or more predetermined character IDs overlap with the target character. Here, a character ID of one character and a character ID of another character are assumed to be included in the two or more predetermined character IDs.

In this case, the disposition unit 12, first, disposes one character at one operation start position of one area in accordance with an instruction from one user. Here, the one character has a “blowing off fire” technique. Next, the command setting unit 14 sets a command for moving from one operation start position to a virtual unit space adjacent to a virtual unit space in which a target character is present and activating a technique for the target character in one character in accordance with an instruction from one user. Similarly, the disposition unit 12 disposes another character at another operation start position of another area in accordance with an instruction from another user. This another character has an “ice” technique. Next, the command setting unit 14 sets a command for moving from another operation start position to a virtual unit space adjacent to a virtual unit space in which a target character is present and activating a technique for the target character in another character in accordance with an instruction from another user.

Then, the operation control unit 18 operates one character on the basis of commands and an execution order of the commands set in accordance with an instruction of command execution for one character, which is performed by one user, received through the execution reception unit 16. The operation control unit 18 causes other characters to similarly operate. In a case in which one character arrives at a virtual unit space adjacent to the target character, the operation control unit 18 generates a derived object (for example, an object of the “blowing off fire” technique) of one character in the target character. Furthermore, in a case in which another character has arrived at a virtual unit space adjacent to the target character, the operation control unit 18 generates a derived object (for example, an object of an “ice” technique) of another character in the target character.

In other words, the operation control unit 18 acquires operation information including an effect on a target character that is stored in the object interference information storing unit 226 in association with a character ID of one character, a character ID of another character, and an object ID of a derived object. Then, the operation control unit 18 causes the target character to execute an operation in which an ice block that is a derived object of another character is melted to generate water in accordance with a frame of one character, and the target character evolves. The determination unit 26 determines whether or not the target character has evolved and, in a case in which it has evolved, generates a predetermined effect in each user.

In addition, in a case in which a target character is a character that “evolves” under the presence of “water”, a method for causing this target character to evolve is not limited to that described above. For example, by using a character having a “water discharging” technique, this technique can be activated for a target character, a target character can be caused to evolve by disposing environment objects such as a “waterfall”, a “river”, and the like in a virtual unit space in the vicinity of the target character, or a target character can be captured by disposing an environment object such as a “mountain” or the like in a virtual unit space in the vicinity of the target character. In other words, in the simulation system 1, various techniques of various characters and/or objects having various features are utilized, and each user can enjoy the process of achieving a set target.

### Example 3 of Set Target: Arrival at Predetermined Place of Another Area

Arrival of one character of one user at a predetermined virtual unit space (hereinafter, referred to as a “goal place”) of another area of another user can be set as a target. In this case, the command setting unit 14 sets commands and an execution order of the commands for one character advancing from one operation start position of one area toward the goal place according to an instruction from one user. On the other hand, for blocking the arrival of one character at the goal place according to an instruction from another user, the command setting unit 14 sets a command for disposing a predetermined object inside another area, a command causing another character to perform a predetermined operation, and an execution order of the commands. The command set in the other character, for example, is a command that is determined by another user by assuming a course of one character and is an operation command for blocking advancement of the one character in a predicted course of the one character, a command for surrounding the one character by using a plurality of other characters, or the like.

Then, the operation control unit 18 causes one character to operate on the basis of commands and an execution order of the commands set in accordance with an instruction of command execution for one character according to one user received through the execution reception unit 16. The operation control unit 18 causes other characters to similarly operate. In a case in which one character escapes from blocking of other characters and objects and arrives at a goal place, the determination unit 26 determines that the one character has achieved the target and generates a predetermined effect for one user. On the other hand, in a case in which the one character is blocked by other characters and objects and is determined not to have arrived at the goal place, the determination unit 26 determines that the one character has not achieved the target and generates a predetermined effect for other users.

### Example 4 of Set Target: Setting HP of Other Character to Zero

One character of one user activating a technique for another character of another user to set the HP of the other character to zero or set the HP to be equal to or smaller than a predetermined value may be set as a target. In this case, as one example, in a case in which one character advances from one operation start position of one area toward a virtual unit space in which another character is present in accordance with an instruction from one user and arrives at a virtual unit space adjacent to this virtual unit space, the command setting unit 14 sets commands and an execution order of the commands for activating techniques for the other character.

Then, the operation control unit 18 operates one character on the basis of commands and an execution order of the commands set in accordance with an instruction of command execution for the one character according to one user received through the execution reception unit 16. In a case in which one character arrives at a virtual unit space adjacent to a virtual unit space in which another character is present, and a technique is activated for the other character, the determination unit 26 determines whether or not the HP of the other character has become zero or has become a predetermined value or less in accordance with this technique of the other character. For example, by referring to the character information storing unit 220, the determination unit 26 determines whether or not the HP of another character has become zero or become a predetermined value or less in accordance with this technique on the basis of “an HP quantity of another character that can be reduced using a technique of one character” stored in association with a character ID of one character and an HP of the other character stored in association with a character ID of the other character. In a case in which the HP of the other character becomes zero or becomes a predetermined value or less, the determination unit 26 determines that one character has achieved the target and generates a predetermined effect in the one user. On the other hand, in a case in which the HP of the other character has not become zero or has not become a predetermined value or less, the determination unit 26 may determine that the target of the one character has not been achieved and generate a predetermined effect for another user.

### (Method of Executing Simulation of Simulation System 1)

In the simulation system 1, although there is no particular limit on the execution of commands and the flow of a process, for example, they can be executed using any method of one of a real-time system, a turn system, and a hybrid system of a real-time system and a turn system.

### <Real-Time System>

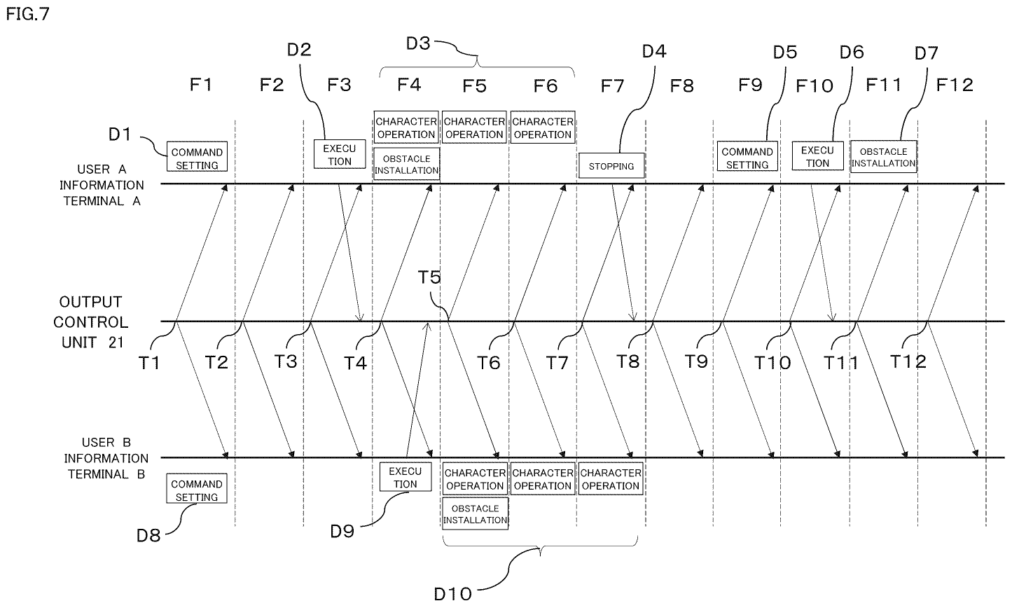

FIG. 7 illustrates an example of an outline of the flow of processing of a case in which processing of the simulation system according to an exemplary embodiment is a real-time system. The simulation system 1 illustrated in FIG. 7 includes an information terminal A of a user A having an input unit 10 and an output unit 20, an information terminal B of a user B having an input unit 10 and an output unit 20, and a server including components, which include at least an output control unit 21, other than the input unit 10 and the output unit 20 and executes a simulation. In addition, in a process performed through a network, although a process (a standby process or the like) in which a delay time (lag) according to a difference and the like between line speeds of lines used by users is taken into account is necessary, here, description of the relating process will be omitted without being considered for simplification of description.

In FIG. 7, the time advances from the left side to the right side, and “Fx” (here, x is a positive integer) represents a frame. In other words, in a real-time system, the simulation system 1 handles a time inside a virtual space 100 in units of frames (a unit acquired by dividing one second into a plurality of parts) and manages the time in units of frames.

First, in the real-time system, the simulation system 1 constantly executes commands with a predetermined period in the virtual space 100. In other words, the simulation system 1 executes various processes in real time and receives commands for a character and/or an object from each user at arbitrary timings, receives an execution instruction of the commands from each user at an arbitrary timing, and then, operates each character and/or each object in real time.

More specifically, the output control unit 21 supplies a snapshot representing a state of the virtual space 100 to the information terminal A and the information terminal B at a predetermined timing. Each of the output units 20 of the information terminal A and the information terminal B performs rendering on the basis of this snapshot and outputs the state of the virtual space 100. For example, the output control unit 21 generates a snapshot representing the state of the virtual space 100 in a first frame (F1) at a predetermined timing T1 and supplies the generated snapshot to the information terminal A and the information terminal B. Each of the output units 20 of the information terminal A and the information terminal B outputs the state of the virtual space 100 on the basis of the received snapshot. The output control unit 21 sequentially generates snapshots of the virtual space 100 at timing set in advance and supplies the snapshots to the information terminal A and the information terminal B. In the example illustrated in FIG. 7, the output control unit 21 generates a snapshot of the virtual space 100 of a frame Fx for every predetermined timing Tx (here, x is a positive integer) and supplies the generated snapshot to the information terminal A and the information terminal B.

For example, in the first frame F1, the command setting unit 14 receives an instruction from the user A and sets predetermined commands for a character A and an object A (an obstacle) owned by the user A (D1). The predetermined commands, for example, are a command for disposing the character A in a predetermined virtual unit space of an area A associated with the user A and causing the character A to sequentially execute three operations (for example, one operation is executed in one frame) and a command for disposing the object A in a predetermined virtual unit space of the area A. Similarly, in the first frame F1, the command setting unit 14 receives an instruction from the user B and sets predetermined commands in a character B and an object B (an obstacle) owned by the user B (D8). The predetermined commands, for example, are a command for disposing the character B in a predetermined virtual unit space of an area B associated with the user B and causing the character B to sequentially execute three operations (for example, one operation is executed in one frame) and a command for disposing the object B in a predetermined virtual unit space of the area B. The command setting unit 14 receives instructions from the user A and the user B and sets such commands in the first frame F1.

Subsequently, the execution reception unit 16 receives an execution instruction (D2) of commands from the user A through the input unit 10. In addition, the execution reception unit 16 receives an execution instruction (D9) of commands from the user B through the input unit 10. The execution reception unit 16 receives an execution instruction at an arbitrary timing of each user. In the example illustrated in FIG. 7, the execution reception unit 16 receives an execution instruction from the user A in a third frame F3 and receives an execution instruction from the user B in a fourth frame F4. Then, in a case in which the execution reception unit 16 receives an execution instruction from the user A in a third frame F3, the operation control unit 18 operates the character A inside the virtual space 100 and disposes the object A in a virtual unit space designated by the user A on the basis of commands and an execution order set by the command setting unit 14. Similarly, in a case in which the execution reception unit 16 receives an execution instruction from the user B in a fourth frame F4, the operation control unit 18 operates the object B inside the virtual space 100 and disposes the object B in a virtual unit space designated by the user B on the basis of commands and an execution order set by the command setting unit 14.

Then, the output control unit 21 respectively generates snapshots representing states of the character A, the object A, the character B, and the object B inside the virtual space 100, which are controlled by the operation control unit 18, in a fourth frame F4, a fifth frame F5, a sixth frame F6, and a seventh frame F7. Then, the output control unit 21 supplies a snapshot of the fourth frame F4 at a timing T4, a snapshot of the fifth frame F5 at a timing T5, a snapshot of the sixth frame F6 at a timing T6, and a snapshot of the seventh frame F7 at a timing T7 to the information terminal A and the information terminal B.

Then, each of the output units 20 of the information terminal A and the information terminal B outputs a state in which the object A is disposed in a predetermined virtual unit space in the fourth frame F4 (D3) by the character A sequentially executing three operations over the fourth frame F4 to the sixth frame F6 and outputs a state in which the object B is disposed in a predetermined virtual unit space in the fifth frame F5 (D10) by the character B sequentially executing three operations over the fifth frame F5 to the seventh frame F7.

In other words, every time the execution reception unit 16 receives an execution instruction of commands from each user, the output control unit 21 generates a snapshot of a situation of the virtual space 100 in which an execution result of commands from each user is reflected and causes the output units 20 of the information terminal A and the information terminal B to output the situations of the virtual space 100.

In addition, in a case in which the execution reception unit 16 receives a stop instruction (D4) for commands from the user A through the input unit 10, the operation control unit 18 stops the execution of commands set by the command setting unit 14. In other words, in the simulation system 1, a command can be stopped at a user's arbitrary timing. Then, the output control unit 21 generates a snapshot of the situation of the virtual space 100 after the command is stopped (in FIG. 7, the snapshot is generated in the seventh frame F7; the states of the character B and the object B are also included in this snapshot) and causes the output units 20 of the information terminal A and the information terminal B to output this situation of the virtual space 100 (in FIG. 7, this situation is output in the eighth frame).

As described above, for example, in a ninth frame F9 illustrated in FIG. 7, after a command (for example, an installation command based on designation of the user A of a predetermined object A into a predetermined virtual unit space of the inside of the area A) is set (D5) by the command setting unit 14, an execution instruction (D6) of a command from the user A is assumed to be received in a 10th frame by the execution reception unit 16. In this case, the output control unit 21 generates a snapshot representing a state in which the operation control unit 18 disposes the object A in a predetermined virtual unit space in the 10th frame F10 and, at a timing T11 (that is, an 11th frame F11), supplies this snapshot to the information terminal A and the information terminal B. Each of the output units 20 of the information terminal A and the information terminal B outputs a state (D7) in which the object A is installed in a predetermined virtual unit space of the area A on the basis of this snapshot (the 11th frame F11).

In addition, in a case in which a stop instruction for command execution is received from a user through the input unit 10, in a case in which there is a command that has not been executed among commands set by the command setting unit 14, the execution reception unit 16 can cause the command that has not been executed to remain as it is. Then, in a case in which a start instruction for command execution is received again, the execution reception unit 16 may restart the command that has not been executed. In addition, in a case in which a stop instruction for command execution has been received from a user by the execution reception unit 16, in a case in which there is a command that has not been executed, the command setting unit 14 can receive setting of a new command from a user and overwrite a new command into the command that has not been executed.

In this way, in a case in which the simulation system 1 operates in a real-time system, in a case in which one user stops execution of a command for one character, unless execution of a command is restarted, a new command is set, or execution of a command after change is not started after a command set once is changed, one character inside the virtual space 100 maintains the stopping state. On the other hand, in a relating state, another character of another user can freely operate in accordance with a command from the other user. In addition, even while one user sets a command, the other user can execute the command set in advance. Thus, in the simulation system 1, a simulation in which not only which operation a character is caused to execute is reviewed, while an operation of a character and a timing of operation start of the partner side are predicted, a strategy and a tactic requiring that which operation that character is caused to start at a certain timing is considered and having instantaneousness for changing movement of its own character in accordance with movement of a partner character can be enjoyed between one user and another user.

In addition, in a case in which the simulation system 1 operates in a real-time system, execution timings of commands set for a character and an object can be arbitrarily determined by a user. Thus, for example, it is possible not only to set a plurality of commands and an execution order of the commands in a plurality of characters and/or a plurality of objects and execute all the commands at one timing (that is, commands are accumulated, and all the commands are executed at one timing) but also to set only one command in one character and sequentially execute the command every time the command is set. In accordance with this, in the simulation system 1, for example, in a case in which a target set by one user is to cause one character to penetrate into another area of another user, a command for disposing a plurality of other characters and a plurality of other objects near a boundary between another area and the one area is set by another user, and, at a timing at which one character is predicted to be close to this boundary, a tactic of executing all the set commands or the like can be enjoyed.

### <Turn System>

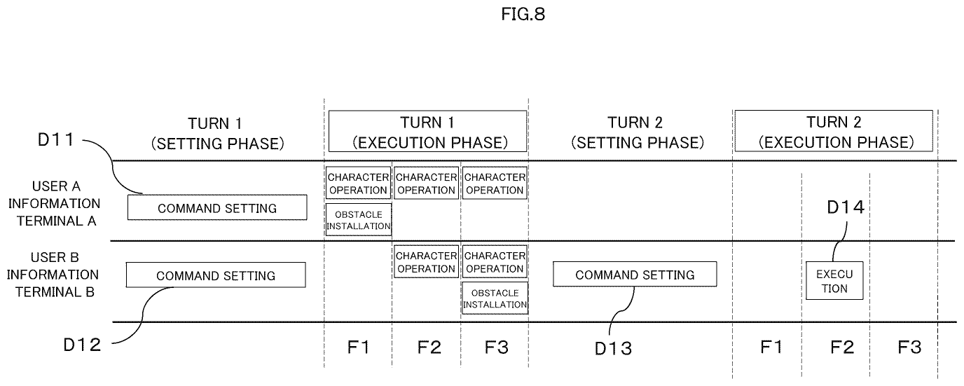

FIG. 8 illustrates an example of an outline of the flow of processing of a case in which processing in the simulation system according to an exemplary embodiment is a turn system. In FIG. 8, the time advances from the left side to the right side.

The simulation system 1 can execute a process in a turn system. In other words, the simulation system 1 can execute a simulation using a turn system having a turn for setting commands (a setting phase) and an execution order of the commands and a turn for executing set commands (an execution phase) as one set. In this case, the simulation system 1 repeatedly executes a turn formed from the setting phase and the execution phase. Thus, in the turn system, the simulation system 1 causes characters and/or objects to simultaneously operate in the execution phase on the basis of a command of each user set in the setting phase.

As illustrated in FIG. 8, in the turn system, the simulation system 1 has a plurality of turns for execution. In other words, a plurality of turns x (here, x is a positive integer) are provided, and an execution phase and an execution phase are included in each turn. In the setting phase, each user can set one or more commands and an execution order of the commands for a character and/or an object owned by him or her. In addition, the execution phase is configured to include a plurality of frames. In the example illustrated in FIG. 8, although the execution phase is configured to include three frames, the number of frames is not limited to three but may be one or more. Here, the command setting unit 14 can set a frame in which a character is caused to appear in the virtual space 100, a frame in which an object is caused to appear in the virtual space 100, and a frame in which commands set in a character and an object are executed in accordance with a user's instruction.

In the example illustrated in FIG. 8, first, in the setting phase of turn 1, the command setting unit 14 receives an instruction from a user A and sets predetermined commands in a character A and an object A (an obstacle) owned by the user A (D11). The predetermined commands, for example, are a command for disposing the character A in a predetermined virtual unit space of an area A associated with the user A and causing the character A to continuously execute three operations (for example, a command for executing one operation in each of a first frame F1 to a third frame F3 of the execution phase of the turn 1) and a command for installing the object A in a predetermined virtual unit space of the area A (for example, a command for installing the object in the first frame of the execution phase). In addition, the command setting unit 14 receives an instruction from a user B and sets predetermined commands in a character B and an object B (an obstacle) owned by a user B (D12). The predetermined commands, for example, are a command for disposing a character B in a predetermined virtual unit space of an area B associated with the user B and causing the character B to continuously execute two operations (for example, a command for executing one operation in each of a second frame F2 and a third frame F3 of the execution phase of the turn 1) and a command for disposing the object B in a predetermined virtual unit space of the area B (for example, a command for installing the object in the third frame of the execution phase).

Next, in the execution phase of the turn 1, commands set in the setting phase of the turn 1 are executed. In the example illustrated in FIG. 8, the character A sequentially executes three operations from the first frame F1, the character B sequentially executes two operations from the second frame F2, the object A is installed in a predetermined virtual unit space of the area A in the first frame F1, and the object B is installed in a predetermined virtual unit space of the area B in the third frame F3.

Subsequently, an execution phase of turn 2 is executed. In the example illustrated in FIG. 8, only the user B sets a predetermined command (D13). This predetermined command, for example, is a command for installing an object in a predetermined frame among a plurality of frames configuring an execution phase of the turn 2 (for example, a command for installing an object in a predetermined virtual unit space of the area B in a second frame F2 of the execution phase of the turn 2). In this case, when the execution phase of the turn 2 is executed, the operation control unit 18 installs an object in a predetermined virtual unit space of the area B in the second frame of the execution phase of the turn 2 (D14). Each of the output units 20 of the information terminal A of the user A and the information terminal B of the user B outputs an execution phase state.

Here, the output control unit 21, in the execution phase of each turn, can be able to be configured to output or not to output movement in a next execution phase (that is, an execution phase in which details of this setting phase are performed) of another character of another user to the information terminal of one user. Here, in a case in which one character of one user and another character interfere with each other, in order not to allow each user to notice occurrence of a certain interference, the output control unit 21 may not output movement of another character in the next execution phase.

In addition, even when switching from the setting phase of each turn to the execution phase may be performed by being triggered upon elapse of a predetermined time, the switching may be performed by being triggered upon reception of execution instructions of commands from all the users after all the users set commands and execution orders of the commands in the setting phase. In addition, there may be limits on the number of commands that can be set for each turn and the number of characters and/or objects that can be used. Furthermore, an upper limit may be set to the number of turns. For example, together with setting a target to be achieved to each user, an upper limit may be set on the number of turns up to the achievement of the target. In a case in which a user cannot achieve this target until the upper limit of the number of turns, the simulation system 1 can stop the execution of the simulation.

In addition, in the setting phase of each turn, a plurality of users may be configured to be able to simultaneously set commands, or commands may be configured to be able to set in accordance with a predetermined order among a plurality of users. In a case in which commands are able to be set in accordance with a predetermined order among a plurality of users in the setting phase of one turn, in the setting phase of the next turn, to the order can be reversed. In other words, in a case in which the user A sets commands first in the setting phase of one turn, and the user B sets commands next, in the setting phase of the next turn, the user B sets commands first, and the user A can set commands next.

### <Hybrid System>

The simulation system 1 can be also executed using a hybrid system of a real-time system and a turn system in the flow of execution of commands and the process. In a case in which there is a user satisfying predetermined conditions in a case in which the process of the simulation system 1 is executed in the real-time system, only the user can set commands for a character of this user and an execution order of the commands and a time frame in which commands can be executed. The predetermined conditions, for example, are consumption of a predetermined item, consumption of virtual currency that can be used inside simulation system 1, and the like.

### [Flow of Processing of Simulation System 1]

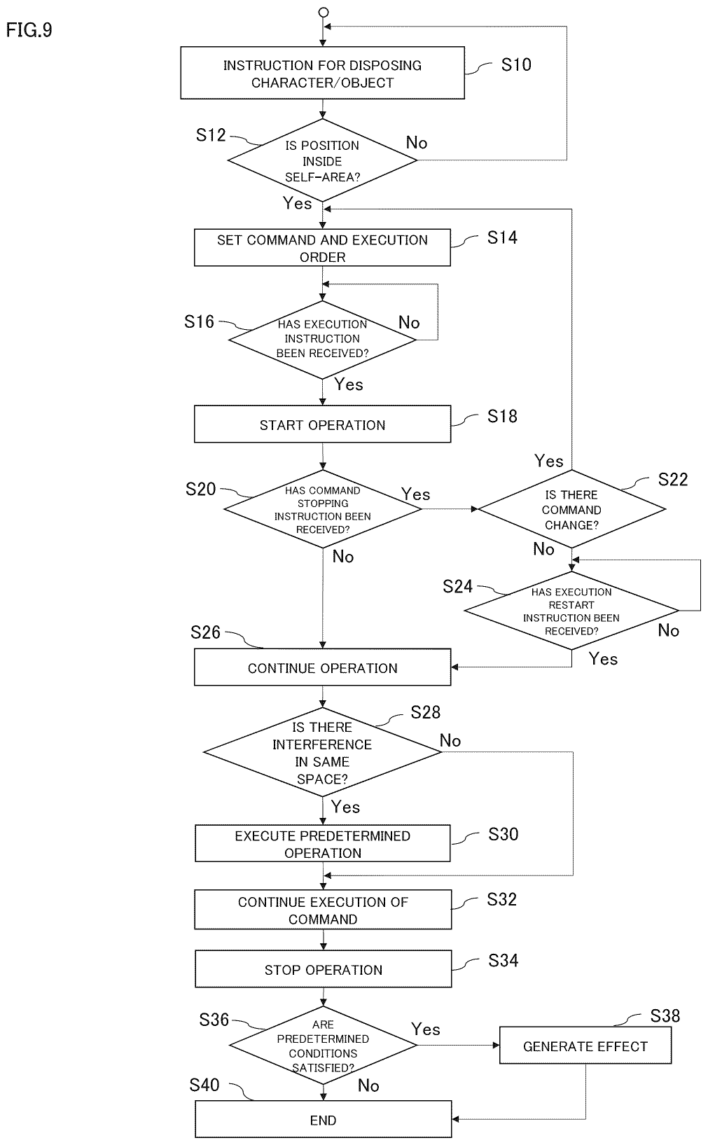

FIG. 9 illustrates one example of the flow of processing of a simulation system according to an exemplary embodiment. In FIG. 9, an example in which one user (hereinafter, referred simply to as a “user”) executes a simulation in the simulation system together with another user will be described from a viewpoint of one user. In addition, predetermined conditions to be achieved are assumed to be set to a user using a character owned by the user.

First, the output unit 20 of the information terminal of the user is controlled by the output control unit 21 and, by referring to the character information storing unit 220 and/or the object information storing unit 225, outputs a character and/or an object to be perceivable for the user (for example, this represents that they are displayed in a display unit of the information terminal; hereinafter the same). Then, the input unit 10 receives an instruction for selecting one or more characters and/or objects to be operated in the virtual space 100 from among the output characters and/or objects from the user. In addition, the output unit 20 outputs the virtual space 100 and a plurality of virtual unit spaces 110 configuring the virtual space 100 to the user so that the user can perceive them. Then, the input unit 10 receives an instruction for selecting a virtual unit space 110 for disposing a character and/or an object from among a plurality of output virtual unit spaces 110 from the user. In this case, in a case in which a plurality of characters and/or a plurality of objects are present, for each of the plurality of characters and/or the plurality of objects, the input unit 10 receives designation of the position of the virtual unit space 110 in which the characters and the objects are disposed (Step 10; hereinafter a step will be denoted as “S”.).

The disposition unit 12 checks whether or not the position of the virtual unit space 110 that is designated (hereinafter, referred to as a “designation position”) is present inside an area (self-area) associated with a user (S12). In a case in which a character and/or an object of which designation positions are not present inside the self-area are present (No in S12), the disposition unit 12 requests the user to retry setting of the designation positions such that the designation positions of the character and/or the object are inside the self-area (S10). On the other hand, in a case in which, in each character and/or each object, designation positions are present inside the self-area (Yes in S12), the disposition unit 12 disposes each of one or more characters and/or objects in a predetermined virtual unit space 110 in accordance with an instruction for selecting one or more characters and/or objects and designation of positions in the virtual unit space 110 at which one or more characters and/or objects are disposed that have been received by the input unit 10.

Subsequently, the command setting unit 14 outputs various commands stored in the command information storing unit 222 to the user from the output unit 20 so that the user can perceive it. The command setting unit 14 sets one or more commands to be executed in the virtual space 100 and the execution order of the commands for each of one or more characters disposed in the virtual unit space 110 in accordance with an instruction received from the user who is referred to the output commands (S14). Further, in a case in which the execution reception unit 16 has received the user's instruction for executing the commands through the input unit 10 (Yes in S16), the operation control unit 18 starts an operation of the character in accordance with the commands and the execution order of the commands which are set for the character by the command setting unit 14 (S18). On the other hand, in a case in which the execution reception unit 16 has not received the user's instruction for executing the commands through the input unit 10, the execution reception unit 16 waits until the execution instruction is received (No in S16). In addition, in a case in which the simulation system 1 operates in the real-time system, users other than this user can freely perform setting of commands and/or execution of the commands independently from an operation of this user.

Here, in a case in which an instruction for stopping command execution from a user, which is received through the input unit 10, has been received (Yes in S20), the operation control unit 18 stops the command that is in the middle of execution. Then, in a case in which an instruction for changing a command has been received through the input unit 10 (Yes in S22), the command setting unit 14 changes some or all of commands set in a character and/or an object (S14). On the other hand, in a case in which an instruction indicating no change of a command has been received by the command setting unit 14 through the input unit 10 (No in S22), the operation control unit 18 waits for execution of commands set in characters and/or objects until an execution instruction for a command (that is, an instruction for restarting execution of a command) (No in S24). Then, in a case in which an execution instruction for commands has been received from a user through the input unit 10 (Yes in S24), the operation control unit 18 restarts execution of commands set in a character and/or an object and continues operations based on the commands (S26). In addition, also in a case in which there is no instruction for stopping execution of commands from a user (No in S20), the operation control unit 18 continues the operations based on the commands (S26).

Further, in a case in which interference has occurred between a character that operates in the virtual space 100 in accordance with a command and another character, an object, and/or a predetermined virtual unit space 110 (Yes in S28), the operation control unit 18 causes the character to execute a predetermined operation based on a relation between the character and the other character, the object, and/or the predetermined virtual unit space 110 (S30). The operation control unit 18 causes the character to execute a predetermined operation, based on operation information stored in the character interference information storing unit 223, the space interference information storing unit 224, and/or the object interference information storing unit 226. Examples of the predetermined operation include various operations described above.

Then, the operation control unit 18 causes the character to execute an operation based on the interference and then causes the character to continue execution of the commands set by the command setting unit 14 (S32). In addition, after the character is caused to execute the operation based on the interference, the operation control unit 18 may cause the character to execute a predetermined operation by canceling the command set by the command setting unit 14. On the other hand, in a case in which an interference has not occurred between a character that operates inside the virtual space 100 in accordance with a command and another character, an object, and/or a predetermined virtual unit space 110 (No in S28), the operation control unit 18 causes the character to continue execution of the commands set by the command setting unit 14 (S32). Subsequently, in a case in which the execution of commands set by the command setting unit 14 has been completed, the operation control unit 18 stops the operation of the character (S34).

Next, the determination unit 26 determines whether or not predetermined conditions set in the user are satisfied in accordance with the operation of the character (S36). In a case in which it is determined that the predetermined conditions are satisfied (Yes in S36), the determination unit 26 generates a predetermined effect for the user (S38). Then, after the predetermined effect is generated, the simulation system 1 ends the operation (S40). In addition, also in a case in which the determination unit 26 determines that the predetermined condition is not satisfied (No in S36), the simulation system 1 ends the operation (S40).

### [Simulation Program]

Components included in the simulation system 1 according to an exemplary embodiment illustrated in FIGS. 1 to 9 can be realized by causing an arithmetic processing device such as a central processing unit (CPU) to execute a program (that is, a simulation program), that is, processing of software. In addition, the components can also be realized by writing a program in advance to hardware as an electronic component such as an integrated circuit (IC). Note that software and hardware can also be used together.

The simulation program according to an exemplary embodiment can be incorporated in advance into, for example, an IC, a ROM, or the like. In addition, the simulation program is a file in an installable format or an executable format, and can be recorded on a computer-readable recording medium such as a magnetic recording medium, an optical recording medium, or a semiconductor recording medium and provided as a computer program. A storage medium that stores the program may be a non-transitory storage medium such as a CD-ROM or a DVD. Further, it is also possible to store the simulation program in advance in a computer connected to a communication network such as the Internet so that it can be provided by being downloaded via the communication network.

The simulation program according to an exemplary embodiment causes a CPU or the like to function as the input unit 10, the disposition unit 12, the command setting unit 14, the execution reception unit 16, the operation control unit 18, the output unit 20, the output control unit 21, the storage unit 22, the editing unit 24, the determination unit 26, the character information storing unit 220, the unit space information storing unit 221, the command information storing unit 222, the character interference information storing unit 223, the space interference information storing unit 224, the object information storing unit 225, the object interference information storing unit 226, the operation sequence information storing unit 227, and the user information storing unit 228 which are described in FIGS. 1 to 9.

### Advantageous Effects

In the simulation system 1 according to the exemplary embodiments, for the character that can operate inside the virtual space 100, each of a plurality of users can freely set a command for an operation of the character and the execution order of the command for its own character of each user. Further, in the simulation system 1, in a case in which an interference has occurred between the character and another character, an object, and/or a virtual unit space 110 inside a virtual space, it is possible to cause the character to execute a predetermined operation with preference over a command set by a user. Thereby, a command set once is faithfully executed as it is in the related art, but in the simulation system 1, it is possible to cause a character to execute an operation different from a command in accordance with interaction between the character and another character or the like. Thus, according to the simulation system 1, each user can simultaneously observe and enjoy an appearance in which a character executes an operation different from a command set by himself or herself.

In addition, in the simulation system 1, it is possible to cause a character to execute various unexpected operations for each user by various combinations such as a combination of one character and another character, a combination of the one character and an object, and/or a combination of the one character and a virtual unit space. Thus, in the simulation system 1, each user can enjoy a simulation of an operation of a character by enjoying what kind of operation the character executes, that is, by undergoing trial and error of various combinations described above.

Furthermore, in the simulation system 1, by dividing the virtual space 100 into a plurality of areas, one area can be associated with each of a plurality of users. Then, one user installs a character and/or an object owned by him or her inside an area associated with him or her, and, by setting one or more commands can move the character to another area not associated with the user. In accordance with this, the simulation system 1 can generate an interference with another character and/or another object of another user in another area in which one user cannot dispose a character and an object of the user, and one user can enjoy a simulation by assuming a change in the operation of the one character that cannot be predicted from a command set in its own character.

While exemplary embodiment of the present disclosure has been described above, the exemplary embodiments described above are not intended to limit the disclosure as set forth in the scope of claims. In addition, it should be noted that not all combinations of features described in the exemplary embodiments are essential as solutions to the problem addressed by the disclosure. Furthermore, technical elements of the exemplary embodiments described above can be applied independently or applied by being divided into a plurality of units such as program components and hardware components.

### REFERENCE SIGNS LIST

1 Simulation system
10 Input unit
12 Disposition unit
14 Command setting unit
16 Execution reception unit
18 Operation control unit
20 Output unit
21 Output control unit
22 Storage unit
24 Editing unit
26 Determination unit
50, 52, 54, 54a, 54b, 54c, 56 Character
60, 60a Object
100 Virtual space
101,101a,101b,101c Area
102 Lower surface
110,110a,110b Virtual unit space
111, 111a, 111b, 111c, 111d, 111e, 111f, 111g, 111h, 111i, 111j, 111k, 111l, 111m, 111n Virtual unit space
220 Character information storing unit
221 Unit space information storing unit
222 Command information storing unit
223 Character interference information storing unit
224 Space interference information storing unit
225 Object information storing unit
226 Object interference information storing unit
227 Operation sequence information storing unit
228 User information storing unit
300 Command

1. A simulation system comprising:
processing circuitry configured to
set one or more commands for each of characters disposed in a virtual space configured by a plurality of virtual unit spaces and are associated with each of a plurality of users and set an execution order of the commands in a case in which a plurality of commands are set; and
operate the character inside the virtual space based on the commands and the execution order set for the character,
wherein the commands and the execution order are set based on an instruction of each user associated with each character in association with each of one or more characters, and
cause a first character associated with a first user to operate inside the virtual space based on the commands and the execution order set for the first character regardless of an instruction from a second user by receiving an instruction from the first user and cause a second character associated with a second user to operate inside the virtual space based on the commands and the execution order set for the second character regardless of an instruction from the first user by receiving an instruction from the second user.

2. The simulation system according to claim 1, wherein, in a case in which a positional relation of the second character with respect to the first character inside the virtual space satisfies predetermined conditions, the processing circuitry is further configured to
cause at least one of the first character and the second character to execute a predetermined operation with preference over an operation based on the commands set for the first character and the commands set for the second character.

3. The simulation system according to claim 1, wherein the processing circuitry is further configured to
stop an operation of a character owned by a user that is in the middle of the operation inside the virtual space based on a stop instruction from the user, and
receive a new setting of the commands and the execution order instead of the commands and the execution order set for the stopped character.

4. The simulation system according to claim 1, wherein the processing circuitry is further configured to
dispose a character inside the virtual unit space,
wherein the virtual space is configured to include a plurality of areas formed from one or more virtual unit spaces, and each of the plurality of areas is associated with each of the plurality of users, and
wherein, when an operation start position that is a position inside the area at which the character starts an operation is designated, permit designation of the operation start position of the first character inside a first area associated with the first user and prohibit designation of the operation start position of the first character inside a second area not associated with the first user.

5. The simulation system according to claim 1, wherein the processing circuitry is further configured to
dispose an object inside the virtual unit space,
wherein the virtual space is configured to include a plurality of areas formed from one or more virtual unit spaces, and each of the plurality of areas is associated with each of the plurality of users, and
permit installation of the object owned by the first user inside a first area associated with the first user and prohibit installation of the object inside a second area not associated with the first user.

6. The simulation system according to claim 4, wherein, after the first character moves from the operation start position of the first area to the second area based on the command, set the command and the execution order inside the second area for the first character.

7. The simulation system according to claim 1, wherein the processing circuitry is further configured to
receive an instruction of execution and an instruction of stopping of the commands set for the character owned by each of the plurality of users for each of the plurality of users and execute the command or stop the command at a timing at which the instruction of execution or the instruction of stopping is received.

8. The simulation system according to claim 1, wherein the processing circuitry is further configured to operate each of the plurality of characters in real time inside the virtual space by being triggered upon reception of an instruction of execution of the command for each of the plurality of characters.

9. A simulation method of a simulation system operating each character associated with each of a plurality of users, the simulation method comprising:
setting one or more commands for each of characters that disposed in a virtual space configured by a plurality of virtual unit spaces and are associated with a plurality of users and setting an execution order of the commands in a case in which a plurality of commands are set; and
operating the character inside the virtual space based on the commands and the execution order set for the character,
setting the commands and the execution order based on an instruction of each user associated with each character in association with one or more characters, and
operating a first character associated with a first user inside the virtual space based on the commands and the execution order set for the first character regardless of an instruction from a second user by receiving an instruction from the first user, and operating a second character associated with a second user inside the virtual space based on the commands and the execution order set for the second character regardless of an instruction from the first user by receiving an instruction from the second user.

10. A non-transitory computer-readable storage medium storing a simulation program having instructions for a simulation system operating each character associated with each of a plurality of users, the simulation program instructions causing a computer to perform a method, the method comprising:
setting one or more commands for each of characters that can be disposed in a virtual space configured by a plurality of virtual unit spaces and are associated with each of a plurality of users and setting an execution order of the commands in a case in which a plurality of commands are set; and
operating the character inside the virtual space based on the commands and the execution order set for the character,
setting the commands and the execution order based on an instruction of each user associated with each character in association with one or more characters, and
operating a first character associated with a first user inside the virtual space based on the commands and the execution order set for the first character regardless of an instruction from a second user by receiving an instruction from the first user, and operating a second character associated with a second user inside the virtual space based on the commands and the execution order set for the second character regardless of an instruction from the first user by receiving an instruction from the second user.

11. A simulation server comprising:
processing circuitry configured to
set one or more commands for each of characters that can be disposed in a virtual space configured by a plurality of virtual unit spaces and are associated with each of a plurality of users and set an execution order of the commands in a case in which a plurality of commands are set; and
operate the character inside the virtual space based on the commands and the execution order set for the character,
set the commands and the execution order based on an instruction of each user associated with each character in association with one or more characters, and
operate a first character associated with a first user inside the virtual space based on the commands and the execution order set for the first character regardless of an instruction from a second user by receiving an instruction from the first user and operate a second character associated with a second user inside the virtual space based on the commands and the execution order set for the second character regardless of an instruction from the first user by receiving an instruction from the second user.

12. The simulation system according to claim 5, wherein, after the first character moves from the operation start position of the first area to the second area based on the command, set the commands and the execution order inside the second area for the first character.

13. The simulation method of claim 9, wherein, in a case in which a positional relation of the second character with respect to the first character inside the virtual space satisfies predetermined conditions, further comprising:
causing at least one of the first character and the second character to execute a predetermined operation with preference over an operation based on the commands set for the first character and the commands set for the second character.

14. The simulation method of claim 9, further comprising:
stopping an operation of a character owned by a user that is in the middle of the operation inside the virtual space based on a stop instruction from the user; and
receiving a new setting of the commands and the execution order instead of the commands and the execution order set for the stopped character.

15. The simulation method of claim 9, further comprising:
disposing a character inside the virtual unit space,
wherein the virtual space is configured to include a plurality of areas formed from one or more virtual unit spaces, and each of the plurality of areas is associated with each of the plurality of users; and
in response to an operation start position that is a position inside the area at which the character starts an operation is designated, permitting designation of the operation start position of the first character inside a first area associated with the first user and prohibiting designation of the operation start position of the first character inside a second area not associated with the first user.

16. The simulation method of claim 9, further comprising:
disposing an object inside the virtual unit space,
wherein the virtual space is configured to include a plurality of areas formed from one or more virtual unit spaces, and each of the plurality of areas is associated with each of the plurality of users; and
permitting installation of the object owned by the first user inside a first area associated with the first user and prohibiting installation of the object inside a second area not associated with the first user.

17. The simulation method of claim 9, further comprising:
after the first character moves from the operation start position of the first area to the second area based on the command, setting the command and the execution order inside the second area for the first character.

18. The simulation method of claim 9, further comprising:
receiving an instruction of execution and an instruction of stopping of the commands set for the character owned by each of the plurality of users for each of the plurality of users and execute the command or stop the command at a timing at which the instruction of execution or the instruction of stopping is received.

19. The simulation method of claim 9, further comprising:
operating each of the plurality of characters in real time inside the virtual space by being triggered upon reception of an instruction of execution of the command for each of the plurality of characters.
